(19) United States
(12) Patent Application Publication
(10) Pub. No.: US 2026/0051184 A1
(43) Pub. Date: Feb. 19, 2026

(54) SYSTEMS AND METHODS FOR ANALYSIS OF MICROPOROUS ANNEALED PARTICLE SCAFFOLDS

(71) Applicant: Duke University, Durham, NC (US)

(72) Inventors: Tatiana Segura, Durham, NC (US); Lindsay Riley, Durham, NC (US); Peter Cheng, Durham, NC (US)

(21) Appl. No.: 19/101,150

(22) PCT Filed: Aug. 4, 2023
(86) PCT No.: PCT/US2023/029464

§ 371 Date: Feb. 4, 2025

Related U.S. Application Data
(60) Provisional application No. 63/395,136, filed on Aug. 4, 2022.

(51) Int. Cl. G06V 20/69; G06V 10/25; G06V 10/26; G06V 10/762; G06V 20/70

(52) U.S. Cl. CPC G06V 20/695; G06V 10/25; G06V 10/26; G06V 10/762; G06V 20/698; G06V 20/70

(57) ABSTRACT

Technologies for particle scaffold analysis include a computing device that obtains labeled input data indicative of particles positioned in a scaffold domain. The input data may be generated by an imaging system coupled to the computing device or may be generated by simulating a physical system. The computing device determines a cumulative Euclidean distance transform (EDT) for each voxel of void space of the scaffold domain, and determines multiple medial axis landmarks based on the EDT and on a particle configuration. The particle configuration is indicative of a neighboring particle graph. The computing device segments the void space into multiple subunits based on the medial axis landmarks. The computing device may determine multiple scaffold descriptors based on the subunits. Other embodiments are described and claimed.

### CROSS-REFERENCE TO RELATED APPLICATIONS

This application is a national stage entry under 35 U.S.C. § 371(b) of PCT International Application No. PCT/US2023/029464, filed Aug. 4, 2023, which claims the benefit of and priority to U.S. Patent Application No. 63/395,136, entitled “SYSTEMS AND METHODS FOR ANALYSIS OF MICROPOROUS ANNEALED PARTICLE SCAFFOLDS,” which was filed on Aug. 4, 2022, each of which is incorporated herein by reference in its entirety.

### STATEMENT REGARDING FEDERALLY SPONSORED RESEARCH

This invention was made with Government support under Federal Grant nos. 1R01NS112940, 1R01NS079691, and R01NS094599 awarded by the National Institutes of Health, National Institutes of Neurological Disorders and the Stroke. Additional support was provided by Federal Grant no. 1R01AI152568 awarded by the National Institute of Allergy and Infectious Disease. The Government has certain rights to this invention.

### BACKGROUND

Packed particles and the void space (interstitial space, pore space) surrounding them are a trending research topic because of the increasing popularity of granular biomaterials. Granular materials are appealing for a number of applications, including injectable tissue mimics and 3-D bioprinting, because they offer unique properties like shear-thinning behavior, increased material surface area, and the option for discrete heterogeneity. Granular materials made from hydrogel microparticles (microgels) have been used to promote wound healing in a number of disease models, including stroke, myocardial infarction, cutaneous wounds, and spinal cord injury. When microgels pack together, they form a 3-D structure referred to as a granular scaffold, and when the microgels of a granular scaffold are linked together, the resulting stable structure is termed a microporous annealed particle (MAP) scaffold. Packed microgels form void space micro-porosity throughout the scaffold, which allows for unhindered cell infiltration and migration between the particles. Many studies support the notion that local geometry influences cell behavior, and in granular scaffolds, the local geometry sensed by cells is the microarchitecture of the void space.

Typical segmentation methods for void space may utilize or derive data from a Euclidean distance transform (EDT) (distance map) over the void space, where the map indicates distance from void space to nearest particle boundary. Conventional methods often focus on the medial axis (skeleton, backbone) of the space, i.e., points located midway between particles, and rely on locating the local maxima (peaks) of the EDT, which correspond to local center points in space. Methods for finding the medial axis include: 1) morphological approaches, such as thinning (erosion) algorithms (which start at the particle boundaries and erode inward toward the midlines) or dilation algorithms (as in watershed), 2) crash (shock) detection in wave propagation techniques often based on solving a partial differential equation, and 3) EDT-based approaches like finding maximally-inscribed spheres whose centers lie along medial axis points. In general, however, it is nontrivial to accurately locate true peaks in a discretized space.

### SUMMARY

According to one aspect of the disclosure, a computing device for packed particle analysis includes an input manager, a particle configuration engine, a landmark engine, and a segmentation engine. The input manager is to obtain labeled input data indicative of a plurality of particles positioned in a scaffold domain. The particle configuration engine is to compute a void space Euclidean distance transform (EDT) for each voxel of void space of the scaffold domain, wherein the void space is defined between the plurality of particles of the labeled input data and determine a particle configuration based on the labeled input data, wherein the particle configuration is indicative of a neighboring particle graph. The landmark engine is to determine a plurality of medial axis landmarks based on the EDT and the particle configuration, wherein each medial axis landmark comprises a voxel of void space that is a 2D-ridge, a 1D-ridge, or a peak. The segmentation engine is to segment the void space into a plurality of subunits based on the plurality of medial axis landmarks.

In an embodiment, to obtain the labeled input data comprises to generate the labeled input data based on image data from an imaging system. In an embodiment, to obtain the labeled input data comprises to simulate particle packing of the plurality of particles.

In an embodiment, to compute the void space EDT comprises to compute an EDT for each particle of the plurality of particles. In an embodiment, to compute the void space EDT for each particle comprises to compute an EDT within a bounding box centered at each particle whose size is determined by a maximum EDT value of the scaffold domain.

In an embodiment, to determine the plurality of medial axis landmarks comprises to generate tag data for each voxel, wherein the tag data for each voxel is indicative of any particles to the voxel is equidistant. In an embodiment, to determine the plurality of medial axis landmarks comprises to identify voxels as 2D-ridge voxels based on the tag data, wherein each voxel that is associated with a 2D-ridge is equidistant from exactly two particles. In an embodiment, to determine the plurality of medial axis landmarks comprises to identify one or more voxels as 1D-ridge voxels, wherein each 1D-ridge voxel is at an intersection of a plurality of 2D-ridges, wherein to identify the 1D-ridge voxels further comprises to determine a set of smallest loops in the neighboring particle graph, which corresponds to the 1D-ridge voxels; and associate voxels to each smallest loop in the neighboring particle graph using the tag data. In an embodiment, to determine the plurality of medial axis landmarks comprises to identify voxels as peak voxels, wherein each peak voxel is at an intersection of a plurality of 1D-ridges, wherein to identify the peak voxels further comprises to cluster medial axis voxels that share particle neighbors; for each cluster, identify voxels equidistant to the largest number of particles; and of the voxels equidistant to the largest number of particles, identify a voxel with the maximum EDT value as a peak.

In an embodiment, to segment the void space further comprises to associate peaks of the medial axis to define a subunit of the plurality of subunits, wherein to associate the peaks comprises to determine a Euclidean distance between pairs of peaks; determine whether the Euclidean distance is less than a sum of EDT values associated with each peak of the pair of peaks; associate the pair of peaks in response to a determination that the Euclidean distance is less than the sum of EDT values; and partition the set of all peaks into subunits, wherein peaks within each subunit are associated with at least one other peak in the subunit. In an embodiment, to segment the void space further comprises to use a graph of peaks and 1D-ridges to associate 1D-ridges with peaks of a subunit to define the backbone of the subunit, wherein to associate 1D-ridges comprises to identify the minimum EDT value along each 1D-ridge; associate a portion of the 1D-ridge that is closest to the peak of a subunit; and assign remaining void space voxels to the subunit associated with a nearest backbone voxel.

In an embodiment, the segmentation engine is further to segment openings of the plurality of particles along a boundary surface of void space into surface subunits. In an embodiment, to segment the openings comprises to compute an EDT of the void space surface; identify ridge and peak voxels along the void space surface with the EDT; threshold EDT values along the medial axis to form backbone islands that define the surface subunits; and assign remaining void space surface voxels to the surface subunit with a nearest backbone voxel. In an embodiment, the segmentation engine is further to merge the plurality of subunits with a the plurality of surface subunits of the plurality of particles, wherein to merge the plurality of subunits with the plurality of surface subunits comprises to combine subunits that contain voxels associated with the same surface subunit.

In an embodiment, the computing device further comprises an analysis engine to generate a plurality of scaffold descriptors in response to determination of the medial axis landmarks and segmentation of the void space, wherein the plurality of scaffold descriptors comprises global descriptors, subunit descriptors, and non-subunit descriptors. In an embodiment, the analysis engine is further to analyze the plurality of scaffold descriptors, wherein to analyze the plurality of scaffold descriptors comprises to compute size metrics across the plurality of subunits in the scaffold domain; compute connectivity metrics across the scaffold domain; compute path and available regions metrics for an object traversing the void space in the scaffold domain; compute ligand availability metrics for the scaffold domain; or compute isotropy metrics across the plurality of subunits. In an embodiment, the analysis engine is further to apply higher dimensional analysis techniques to the plurality of scaffold descriptors, wherein to apply the higher dimensional analysis techniques comprises to identify subunit types as defined by descriptor values; or identify scaffold domain fingerprints as defined by descriptor values.

According to another aspect, a method for packed particle analysis comprises obtaining, by a computing device, labeled input data indicative of a plurality of particles positioned in a scaffold domain; computing, by the computing device, a void space Euclidean distance transform (EDT) for each voxel of void space of the scaffold domain, wherein the void space is defined between the plurality of particles of the labeled input data; determining, by the computing device, a particle configuration based on the labeled input data, wherein the particle configuration is indicative of a neighboring particle graph; determining, by the computing device, a plurality of medial axis landmarks based on the EDT and the particle configuration, wherein each medial axis landmark comprises a voxel of void space that is a 2D-ridge, a 1D-ridge, or a peak; and segmenting, by the computing device, the void space into a plurality of subunits based on the plurality of medial axis landmarks.

In an embodiment, obtaining the labeled input data comprises generating the labeled input data based on image data from an imaging system. In an embodiment, obtaining the labeled input data comprises simulating particle packing of the plurality of particles.

In an embodiment, computing the void space EDT comprises computing an EDT for each particle of the plurality of particles. In an embodiment, computing the void space EDT for each particle comprises computing an EDT within a bounding box centered at each particle whose size is determined by a maximum EDT value of the scaffold domain.

In an embodiment, determining the plurality of medial axis landmarks comprises generating tag data for each voxel, wherein the tag data for each voxel is indicative of any particles to the voxel is equidistant. In an embodiment, determining the plurality of medial axis landmarks comprises identifying voxels as 2D-ridge voxels based on the tag data, wherein each voxel that is associated with a 2D-ridge is equidistant from exactly two particles. In an embodiment, determining the plurality of medial axis landmarks comprises identifying one or more voxels as 1D-ridge voxels, wherein each 1D-ridge voxel is at an intersection of a plurality of 2D-ridges, wherein identifying the 1D-ridge voxels further comprises determining a set of smallest loops in the neighboring particle graph, which corresponds to the 1D-ridge voxels; and associating voxels to each smallest loop in the neighboring particle graph using the tag data. In an embodiment, determining the plurality of medial axis landmarks comprises identifying voxels as peak voxels, wherein each peak voxel is at an intersection of a plurality of 1D-ridges, wherein identifying the peak voxels further comprises clustering medial axis voxels that share particle neighbors; for each cluster, identifying voxels equidistant to the largest number of particles; and of the voxels equidistant to the largest number of particles, identifying a voxel with the maximum EDT value as a peak.

In an embodiment, segmenting the void space further comprises associating peaks of the medial axis to define a subunit of the plurality of subunits, wherein associating the peaks comprises determining a Euclidean distance between pairs of peaks; determining whether the Euclidean distance is less than a sum of EDT values associated with each peak of the pair of peaks; associating the pair of peaks in response to determining that the Euclidean distance is less than the sum of EDT values; and partitioning the set of all peaks into subunits, wherein peaks within each subunit are associated with at least one other peak in the subunit. In an embodiment, segmenting the void space further comprises using a graph of peaks and 1D-ridges to associate 1D-ridges with peaks of a subunit to define the backbone of the subunit, wherein associating 1D-ridges comprises identifying the minimum EDT value along each 1D-ridge; associating a portion of the 1D-ridge that is closest to the peak of a subunit; and assigning remaining void space voxels to the subunit associated with a nearest backbone voxel.

In an embodiment, the method further comprises segmenting, by the computing device, openings of the plurality of particles along a boundary surface of void space into surface subunits. In an embodiment, segmenting the openings comprises computing an EDT of the void space surface; identifying ridge and peak voxels along the void space surface with the EDT; thresholding EDT values along the medial axis to form backbone islands that define the surface subunits; and assigning remaining void space surface voxels to the surface subunit with a nearest backbone voxel. In an embodiment, the method further comprises merging, by the computing device, the plurality of subunits with a the plurality of surface subunits of the plurality of particles, wherein merging the plurality of subunits with the plurality of surface subunits comprises combining subunits that contain voxels associated with the same surface subunit.

In an embodiment, the method further comprises generating, by the computing device, a plurality of scaffold descriptors in response to determining the medial axis landmarks and segmenting the void space, wherein the plurality of scaffold descriptors comprises global descriptors, subunit descriptors, and non-subunit descriptors. In an embodiment, the method further comprises analyzing, by the computing device, the plurality of scaffold descriptors, wherein analyzing the plurality of scaffold descriptors comprises computing size metrics across the plurality of subunits in the scaffold domain; computing connectivity metrics across the scaffold domain; computing path and available regions metrics for an object traversing the void space in the scaffold domain; computing ligand availability metrics for the scaffold domain; or computing isotropy metrics across the plurality of subunits. In an embodiment, the method further comprises applying, by the computing device, higher dimensional analysis techniques to the plurality of scaffold descriptors, wherein applying the higher dimensional analysis techniques comprises identifying subunit types as defined by descriptor values; or identifying scaffold domain fingerprints as defined by descriptor values.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for void space analysis of granular particle scaffolds;

FIG. 2 is a simplified block diagram of an environment that may be established by a computing device of the system of FIG. 1;

FIG. 3 is a simplified flow diagram of at least one embodiment of a method for void space analysis of granular particle scaffolds that may be executed by a computing device of FIGS. 1 and 2;

FIG. 4 is a simplified flow diagram of at least one embodiment of a method for determining medial axis landmarks that may be executed by the computing device of FIGS. 1 and 2 in connection with the method of FIG. 3;

FIG. 5 is a simplified flow diagram of at least one embodiment of a method for surface opening segmentation and merging that may be executed by the computing device of FIGS. 1 and 2 in connection with the method of FIG. 3;

FIG. 6 is a schematic diagram illustrating a cumulative Euclidean distance transform (EDT) that may be generated by the computing device of FIGS. 1 and 2;

FIGS. 7 and 8 are schematic diagrams illustrating medial axis landmarks that may be generated by the computing device of FIGS. 1 and 2;

FIG. 9 is a schematic diagram illustrating a void space segmentation subunit that may be generated by the computing device of FIGS. 1 and 2;

FIG. 10 is a schematic diagram illustrating ligand availability analysis that may be performed by the computing device of FIGS. 1 and 2;

FIG. 11 is a schematic diagram illustrating path determination that may be performed by the computing device of FIGS. 1 and 2;

FIG. 12 is a schematic diagram illustrating higher order subunit classification that may be performed by the computing device of FIGS. 1 and 2;

FIG. 13 is a diagram illustrating 3D-pore volume for simulated and experimental granular particle scaffolds; and

FIG. 14 is a diagram illustrating experimental results that may be achieved.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

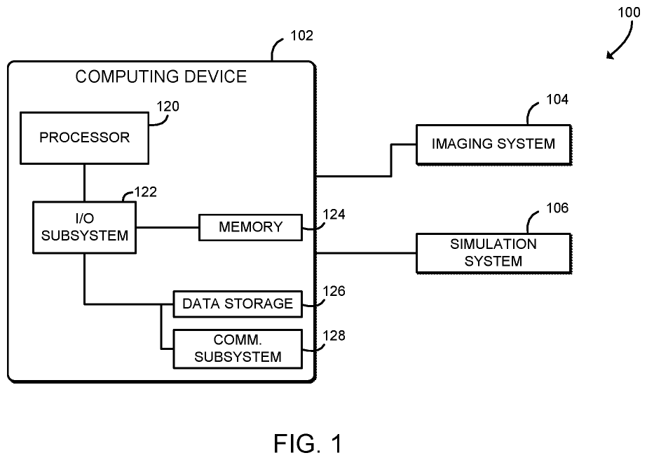

Referring now to FIG. 1, an example illustrative system 100 for void space analysis of granular particle scaffolds includes a computing device 102 and, in some embodiments, an imaging system 104 and/or a simulation system 106. In use, the computing device 102 obtains labeled input data representing the positions of particles within a three-dimensional scaffold domain. The input data may represent experimental data captured, for example, using a microscope or other imaging device of the imaging system 104, or may represent simulated particle packing provided by the simulation system 106. The computing device 102 generates information about the particle configuration by computing cumulative Euclidean distance transform (EDTs) for each particle within the scaffold domain, which allows for the tagging of each voxel by its complete set of nearest particles. Based on these tags, the computing device 102 identifies spatial landmarks in the void space that are subtypes of the medial axis of the void space and, using those landmarks, the computing device 102 segments the void space into three-dimensional subunits (3D-pores) that represent natural pores or openings within the scaffold. As discussed further below, the segmentation performed by the computing device 102 avoids over-segmentation and the need for “pruning” spurious medial axes that may occur with conventional segmentation systems. Additionally, the computing device 102 may use the segmentation and other available data to perform additional analysis, including generating multiple scaffold descriptors indicative of the scaffold domain as a whole, the segmented subunits, and/or non-subunit attributes. Accordingly, the system 100 provides technologies for visualizing and analyzing 3-D packed particles by segmenting the void space into 3-D pores (subunits). The computing device 102 may enable improved analysis and development of granular particle scaffolds, including microporous annealed particle scaffolds. Those improved granular particle scaffolds may generate improvements in biomedical applications or other technical fields.

For example, the computing device 102 may provide improved measurements of the internal geometry of granular scaffolds, which may allow improved material design compared to typical measurement techniques. In the biomaterials field, porosity that is approximated using 2-D microscope images is a commonly-reported quantification of scaffold void space. Porosity is typically reported as a void volume fraction or as a distribution of 2-D “pore” length measurements. However, such estimates of void volume fraction and 2-D approximations of pores disregard the complexity and geometrical variety found in local pockets of 3-D void space, which are measured by the system 100.

Additionally, the computing device 102 studies void space between packed particles, unlike conventional techniques that may consider only the particles themselves. Packed particles have been studied in other fields (mathematics, physics, geoscience, chemistry, agriculture, etc.) without explicit consideration for void space geometry. Such research commonly focuses on the particles themselves, where methods have been developed to identify particle boundaries or construct the graph of touching particles to study particle connectivity, packing configuration, and stress force chains. Yet void space metrics may be more meaningful than particle metrics for certain phenomenon. For example, in landslide and earthquake science, the size and distribution of void space pockets are relevant because these regions permit particle rearrangement and contribute to packed-particle instability. In bioengineering, granular materials are utilized for producing biofuels, manufacturing biologics, and developing therapeutic interventions for wound healing. Such platforms incorporate living organisms, and their efficacy relies on the interactions of these organisms with the local microarchitecture of the void space. For example, cells exert therapeutic effects by responding to biomechanical cues like spatial confinement and surface curvature, and in granular systems, these physical cues derive from the local environment of the void space where they reside. Some particle-focused research has included information about void space, such as Delaunay tessellation by particle centroids to identify the smallest void subunits formed by tetrahedral particle stacking as well as larger pockets of space; however, Delaunay tessellation becomes less suitable when a particle cannot be accurately represented by a single point. A set-Voronoi tessellation uses entire particles as starting objects to divide the space into pods, where each pod contains an individual particle plus the volume of void space closest to it, and in this way, descriptors of pods can capture information about void space. However, segmenting the space by particle-based pods fractionates the so-called 3-D pores (empty regions of space) of the system. The computing device 102 described herein identifies true 3-D pores.

Further, the computing device 102 may provide improved results for segmentation with respect to the medial axis as compared to conventional approaches. For example, the computing device 102 may identify the correct peak voxels when, for example, true peaks lie between grid points or when boundary noise results in spurious local maxima. In contrast, morphological approaches, such as morphological reconstruction, or brute force methods that scan for local maxima using gradually increasing window sizes are prone to miss true peaks and/or identify false ones. Regarding the medial axis, particles with even the slightest of boundary fluctuations can produce extraneous branches that extend from the true medial axis toward the non-smooth boundary regions. The computing device 102 may identify the medial axis without additional pruning methods as required by typical approaches. Even after peaks are identified, the computing device 102 may avoid substantial over-segmentation that occurs if all peaks are naively used to reference unique subunits (as in watershed). Accordingly, preserving the 3-D pockets of open space in the scaffold is akin to delineating the natural “rooms” of the void space separated by narrow “hallways,” which may be advantageous for investigating or designing materials and/or systems where encapsulated or infiltrating cells fit into and interact with the interior of the particle scaffolds.

The computing device 102 may be embodied as any type of device capable of performing the functions described herein. For example, the computing device 102 may be embodied as, without limitation, a desktop computer, a laptop computer, a tablet computer, a wearable computer, a smartphone, a consumer electronic device, a workstation, a server, a rack-mounted server, a blade server, a network appliance, a web appliance, a distributed computing system, a multiprocessor system, and/or any other computing device capable of performing the functions described herein. As shown in FIG. 1, the illustrative computing device 102 includes a processor 120, an I/O subsystem 122, memory 124, a data storage device 126, and communication circuitry 128. Of course, the computing device 102 may include other or additional components, such as those commonly found in a workstation (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the computing device 102 may be embodied as any communication circuit, device, or collection thereof, capable of enabling communications between the computing device 102 and other remote devices. The communication circuitry 128 may be configured to use any one or more communication technology (e.g., wireless or wired communications) and associated protocols (e.g., Ethernet, Bluetooth®, Wi-Fi®, WiMAX, etc.) to effect such communication.

As shown, the computing device 102 may be coupled to an imaging system 104, which may be embodied as one or more optical microscopes, electron microscopes, atomic force microscopes, or other imaging systems. In some embodiments, an imaging system 104 such as a microscope may focus an image onto a camera (e.g., a CMOS sensor device or a charge-coupled device) or other imaging sensor for still image and/or video recording. The computing device 102 may receive image data generated by the imaging system 104.

The computing device 102 may also be coupled to a simulation system 106. The simulation system 106 may be embodied as any type of device capable of performing the functions described herein. For example, the computing device 102 may be embodied as, without limitation, a desktop computer, a laptop computer, a tablet computer, a wearable computer, a smartphone, a consumer electronic device, a workstation, a server, a rack-mounted server, a blade server, a network appliance, a web appliance, a distributed computing system, a multiprocessor system, and/or any other computing device capable of performing the functions described herein. As described further below, the simulation system 106 may perform one or more physical simulations to determine particle packing for a granular particle scaffold or otherwise prepare particle data. In some embodiments, one or more functions of the simulation system 106 may be performed by the computing device 102 or other component(s) of the system 100.

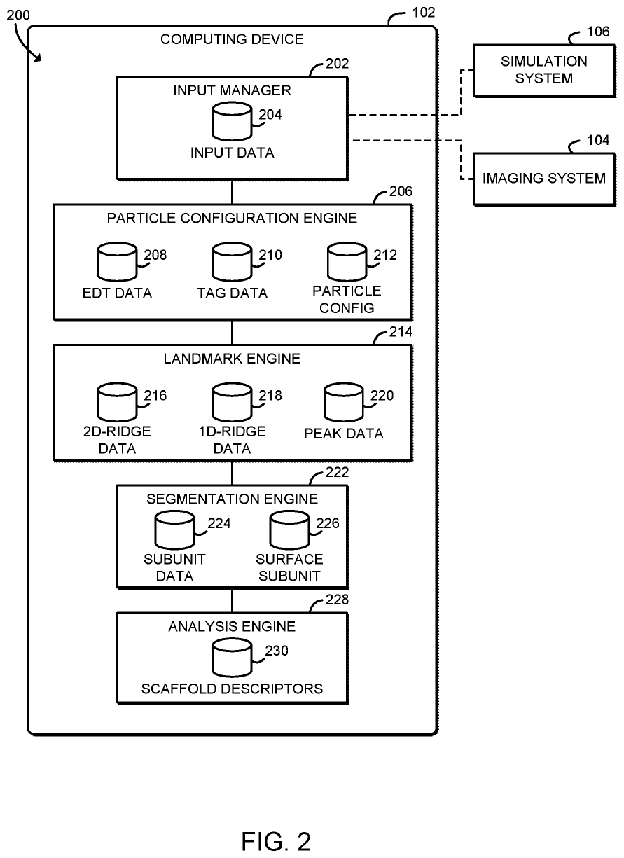

Referring now to FIG. 2, in the illustrative embodiment, the computing device 102 establishes an environment 200 during operation. The illustrative environment 200 includes an input manager 202, a particle configuration engine 206, a landmark engine 214, a segmentation engine 222, and an analysis engine 228. The various components of the environment 200 may be embodied as hardware, firmware, software, or a combination thereof. As such, in some embodiments, one or more of the components of the environment 200 may be embodied as circuitry or a collection of electrical devices (e.g., input manager circuitry 202, particle configuration engine circuitry 206, landmark engine circuitry 214, segmentation engine circuitry 222, and/or analysis engine circuitry 228). It should be appreciated that, in such embodiments, one or more of those components may form a portion of the processor 120, the I/O subsystem 122, and/or other components of the computing device 102.

The input manager 202 is configured to obtain labeled input data 204 indicative of multiple particles positioned in a scaffold domain. The labeled input data 204 may be obtained by generating the labeled input data 204 based on image data from the imaging system 104 or by physically simulating particle packing. For example, the input manager 202 may format or otherwise process particle data generated by a physical simulation of particle packing performed by the simulation system 106 or other particle data. The input manager 202 may be further configured to generate properties of particles included in the input data 204, such as volume and shell voxels.

The particle configuration engine 206 is configured to compute a void space Euclidean distance transform (EDT) 208 for each voxel of void space of in the scaffold domain. The void space is defined between the plurality of particles as the non-particle voxels within the convex hull of particle centers within the labeled input data 204. Computing the void space EDT 208 for each voxel of the void space may include computing an EDT for each particle of the plurality of particles. In some embodiments, an EDT may be computed for each particle within a bounding box centered at each particle whose size is determined by a maximum EDT value of the scaffold domain. The particle configuration engine 206 may be configured, in some embodiments, to generate tag data 210 for each voxel. The tag data 210 for each voxel is indicative of any particles to which that voxel is equidistant. The particle configuration engine 206 is further configured to determine a particle configuration 212 based on the labeled input data 204. The particle configuration 212 is indicative of a neighboring particle graph 212.

The landmark engine 214 is configured to determine multiple medial axis landmarks based on the EDT 208 and the particle configuration 212. Each medial axis landmark may comprise a voxel of void space that is a 2D-ridge 216, a 1D-ridge 218, or a peak 220. Determining the medial axis landmarks may include identifying voxels as 2D-ridge voxels based on the tag data 210. Each voxel that is associated with a 2D-ridge 216 is equidistant from exactly two particles. Determining the medial axis landmarks may include identifying one or more voxels as 1D-ridge voxels. Each voxel that is associated with a 1D-ridge 218 is at an intersection of multiple 2D-ridges 216. Identifying the 1D-ridge voxels may include determining a set of smallest loops in the neighboring particle graph 212, which corresponds to the 1D-ridge voxels, and associating voxels to each smallest loop in the neighboring particle graph 212 using the tag data 210. Determining the medial axis landmarks may include identify voxels as peak voxels. Each voxel that is associated with a peak 220 is at an intersection of multiple 1D-ridges 218. Identifying the peak voxels may include clustering medial axis voxels that share particle neighbors, for each cluster, identifying voxels equidistant to the largest number of particles, and, of the voxels equidistant to the largest number of particles, identifying a voxel with the maximum EDT value 208 as a peak 220.

The segmentation engine 222 is configured to segment the void space into a plurality of subunits based on the plurality of medial axis landmarks. The subunits may be stored in subunit data 224. In some embodiments, segmenting the void space may further include associating peaks 220 from the medial axis to define a subunit. Associating the peaks may include determining a Euclidean distance between pair of peaks, determining whether the Euclidean distance is less than a sum of EDT values associated with each peak of the pair of peaks and, if so, linking the pair of peaks, and partitioning the set of all peaks into subunits, where the peaks within each subunit are associated with at least one other peak in the subunit. In some embodiments, segmenting the void space further includes using a graph of peaks and 1D-ridges to associate 1D-ridges with peaks of a subunit to define the backbone of the subunit. Associating the 1D-ridges with peaks may include identifying the minimum EDT value along each 1D-ridge, associating a portion of the 1D-ridge that is closest to the peak of a subunit, and assigning remaining void space voxels to a subunit associated with a nearest backbone voxel.

In some embodiments, the segmentation engine 222 is further configured to segment openings of the plurality of particles along a boundary surface of void space into surface subunits 226. To segment the openings may include computing an EDT of the void space surface, identifying ridge and peak voxels along the void space surface with the EDT, thresholding EDT values along the medial axis to form backbone islands that define the surface subunits, and assigning remaining void space surface voxels to the surface subunit with a nearest backbone voxel. In some embodiments, the segmentation engine 222 is further configured to merge the plurality of subunits with a plurality of surface subunits of the plurality of particles. Merging the plurality of subunits with the plurality of surface subunits may include combining subunits that contain voxels associated with the same surface subunit.

The analysis engine 228 is configured to generate multiple scaffold descriptors 230 in response to determining the medial axis landmarks and segmenting the void space. The scaffold descriptors 230 may include global descriptors, subunit descriptors, and non-subunit descriptors. The analysis engine 218 is further configured to analyze the scaffold descriptors 230, which may include computing size metrics across the plurality of subunits in the scaffold domain, computing connectivity metrics across the scaffold domain, computing path and available regions metrics for an object traversing the void space in the scaffold domain, computing ligand availability metrics for the scaffold domain, or computing isotropy metrics across the plurality of subunits. In some embodiments, analyzing the scaffold descriptors 230 may include applying higher dimensional analysis techniques to the plurality of scaffold descriptors, including identifying subunit types as defined by descriptor values, or identifying scaffold domain fingerprints as defined by descriptor values.

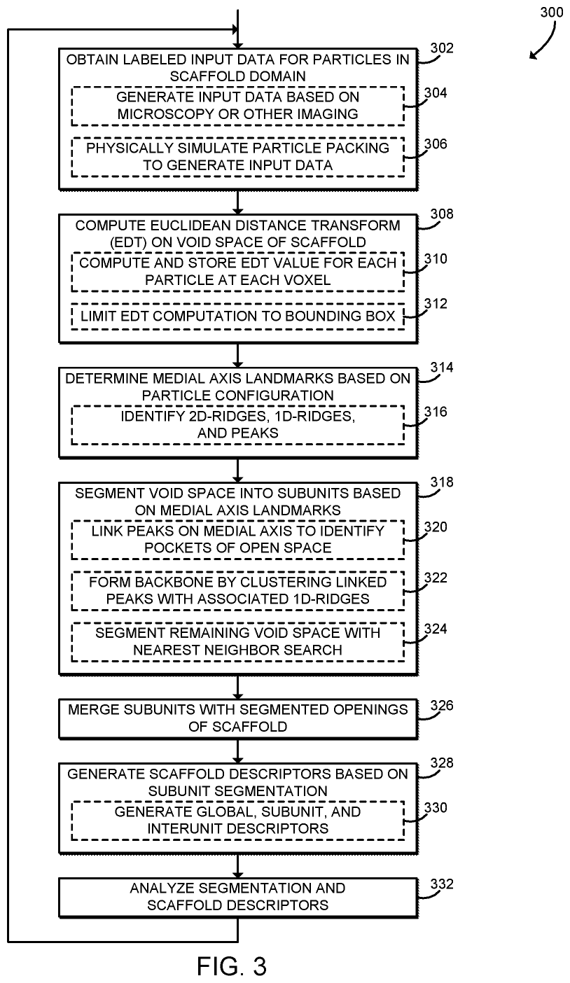

Referring now to FIG. 3, in use, the computing device 102 may execute a method 300 for void space analysis of granular particle scaffolds. It should be appreciated that, in some embodiments, the operations of the method 300 may be performed by one or more components of the environment 200 of the computing device 102 as shown in FIG. 2. The method 300 begins with block 302, in which the computing device 102 obtains labeled input data 204 describing particles positioned in a scaffold domain. Since the location of each particle is processed, a specific input data format (“labeled” domains) is used that highlights individual particles. Each discrete volume element (voxel) associated with a particular particle is labeled with that particle's unique identifying number. In some embodiments, the computing device 102 can convert sphere data (e.g., center and radius) into the labeled domain format. In some embodiments, in block 304 the computing device 102 may generate the input data 204 based on microscopy or other imaging received from the imaging system 104. In some embodiments, in block 306, the computing device 102 may physically simulate particle packing to generate the input data 204. For example, the computing device 102 may simulate granular scaffolds (particle domains) that exhibit physically accurate phenomena, such as particle jamming. Such simulated may not be restricted to a microscope's depth of field. In some embodiments, the computing device 102 may obtain particle data generated by another device, such as the simulation system 106.

In an example, particle domains were simulated (or procedurally generated, in the case of perfect packing) to mimic granular scaffolds. The container size for all simulated particle domains was held constant at 600×600×600 μm to reflect the dimensions of a typical MAP scaffold sample. The scaffold domains were discretized on a uniform Cartesian grid with mesh size dx=2 μm to produce a total voxel count of 2.7×10⁷, which may produce the best trade-off between detail and memory usage.

For perfect packing, square and hexagonal packing domains of rigid spheres may be generated using straightforward custom code (e.g., MATLAB code) that requires inputs of domain size and sphere diameter. Only spheres that fit entirely within the boundaries container may be included. Input data 204 may be written out to a CSV file containing an N×4 matrix, where N is the number of particles, columns 1-3 list the (x, y, z) particle center, and column 4 lists the particle radii.

Randomly packed particle domains may be generated using a three-dimensional modeling application such as SideFX Houdini. Particles may be randomly initialized above a funnel geometry that feeds into the domain container. For rigid spheres, a native rigid-body physics solver may be used to simulate how the rigid particles fall, collide, and ultimately settle in the container. Domains containing binary mixtures may be generated by first determining the number of species 1 and species 2 particles according to the desired volume ratio and container size, then initializing their starting positions (randomly) within a cylinder above the setup. For non-rigid particles, a native finite element physics solver may be used to simulate nonrigid particles. “Semisoft” and “soft” spherical particles may be generated by adjusting the Lamé parameters of the material model used in the finite element solver. Lamé's second parameter is referred to as the dynamic viscosity or shear modulus in other fields. λ and μ are used to describe many relationships between stress and strain, such as Young's modulus (E)=μ·(3λ+2μ)·(λ+μ)−1. Semi-soft particles have Lamé's first parameter, λ, equal to 1000 and Lamé's second parameter, μ, equal to 250, while soft particles have λ=400 and μ=50. The geometry for rough particles may be created using a three-dimensional modeling capabilities, for example where points are randomly scattered on the surface of a sphere to be used as sources of bulging for creating the final effect. In an embodiment, bumps that are approximately 3 μm tall may be added to 100 μm particles.

For non-spherical particles, three-dimensional modeling may be used to model atypical particle shapes, such as ellipsoids and cylinders (rods). Nuggets were created by extruding a parametric curve that describes the perimeter of an egg-like shape. In an illustrative embodiment, ellipsoids are 100 μm along the major axis and 50 μm along the remaining axes. In another embodiment, nuggets are 100 μm long, 65 μm wide, and 30 μm thick. In an embodiment, rods are 100 μm long and 40 μm in diameter. Isotropic ellipsoid domains may be generated by first initializing isotropic ellipsoids in pseudo-hexagonal packing inside the simulation container, then allowing them to settle using the native rigid-body solver.

As described above, for monodisperse, rigid, spherical particle domains, only spheres that fit entirely within the boundaries of the container may be included. For all other domains, particles may be cropped at the height of the container, i.e., 600 μm in the z-direction. Once a domain has been simulated, the particles are rasterized to a uniform 3-D grid, where the mesh size of this grid determines the mesh size of the grid for further processing. Since the domains generated range from rigid spheres to non-rigid custom geometry, a general data format may be required. A map data structure may be used to store information about which grid voxels belong to each particle, where each particle is uniquely labeled with an integer ID. This data structure may then be written out to a JSON file, along with any other fields that may be needed for analysis, such as, but not limited to: domain size, total particle count, total voxel count, voxel count per particle, and voxel size (mesh size). If the particles are rigid spheres, it may not be necessary to rasterize the particles to a grid in order to reliably export their geometry. Instead, a simple CSV file may be used to store their centers and radii. A mesh size may be provided to establish the dimensions of the scaffold domain grid.

For rigid spherical particles described in a CSV file format, data may be converted to a “labeled particle domain” format by generating a bounding box around each particle and identifying voxels that lie within the sphere. For particle domains in the aforementioned JSON file format, parameters and “labeled particle domain” data may be read and stored.

In block 308, the computing device 102 computes a cumulative Euclidean distance transform (EDT) 210 on the void space of the scaffold domain. In some embodiments, in block 310 the computing device 102 may compute and store an EDT value for each particle at each voxel in the void space.

As described above, for each particle domain, a 3-D grid of centered voxel coordinates is generated according to the domain and mesh size. For each particle in the domain, a Euclidean distance transform (EDT) is computed within the particle from the surrounding void space and a threshold of mesh size multiplied by 42 is used to determine the particle's single-voxel-thick edge (surface). The same approach may be used to determine the voxels contained within the particle's shell, e.g., a user-inputted thickness measured from the edge inward that reflects how far into a particle a cell can reach. In addition, each particle's diameter may be stored using a sphere of equivalent volume, as well as each particle's centroid. A scaffold's void space is defined as the non-particle voxels contained within the convex hull of particle centroids.

Instead of computing a single Euclidean distance transform (EDT) of the void space to extract the medial axis as in certain conventional approaches, the computing device 102 computes the EDT for each particle as a way to store how many particles are equidistant to a voxel, as well as which particles are equidistant. This cumulative EDT information is stored at each voxel, employing various algorithmic optimizations described further below to minimize memory and computational overhead. This approach also accommodates non-smooth particles and, notably, removes the need for pruning the medial axis. Performing this step provides the data necessary for identifying medial axis subtypes using the particle configuration, as described further below.

In some embodiments, in block 312, the computing device 102 may limit EDT computation to particles contained within a bounding box surrounding each voxel. Computing the EDT of each particle at every voxel as described above may be computationally expensive and memory-intensive. For example, a typical domain of 10⁷ voxels with 10³ particles would require storage of 10¹⁰ floating-point numbers, which amounts to 80 gigabytes of memory. Thus, the computing device 102 may employ a modified version of the approach described above in some embodiments. First, a single EDT of the void space is computed with respect to all of the particles at once. This single EDT alone does not carry enough information to determine the particles that are equidistant to each voxel; however, the maximum value, EDTₘₐₓ, of this EDT does indicate the maximum distance that any voxel in the void space is from a particle. This implies that when computing the EDT of each particle, it is only necessary to compute the EDT within an axis-aligned bounding box of the particle that is at most EDTₘₐₓ bigger than the particle in all six coordinate directions. Accordingly, for any arbitrary particle, it is guaranteed that any voxel that is not within this bounding box must not be equidistant to this particle and others. Thus, the amount of computational effort compared to calculating EDT for every particle is greatly reduced.

Then, a sparse Boolean matrix is used to document the equidistant particles for each voxel; in particular, element (i, j) is true if the set of equidistant particles to voxel j contains particle i and false otherwise. Because a sparse Boolean matrix is used, no memory allocation is required for the matrix elements that are false. This data structure takes advantage of the fact that each voxel is only equidistant to a relatively small subset of particles in the domain, and therefore, greatly trims down the memory footprint of the method. In practice, the number of true elements in a column may not exceed around 10 for a single domain, which is substantially smaller than the total number of particles in a domain.

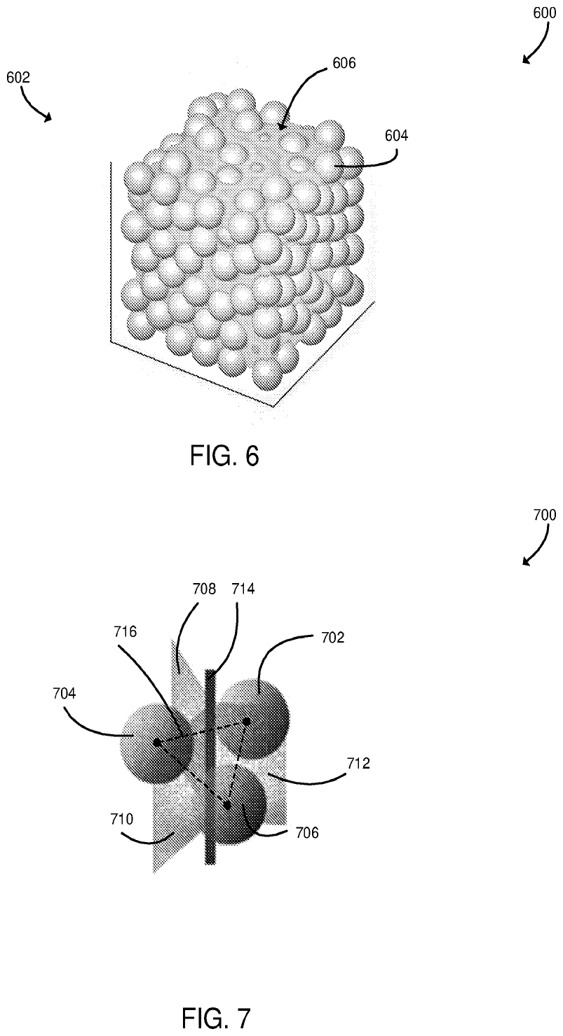

Referring now to FIG. 6, diagram 600 illustrates one illustrative embodiment of a cumulative EDT that may be calculated by the computing device 102. As shown, a scaffold domain 602 includes multiple particles 604 arranged in a randomly distributed scaffold. Void space 606 is defined between the particles 604. Cumulative EDT values may be calculated for each discrete voxel of the void space 606 as described above.

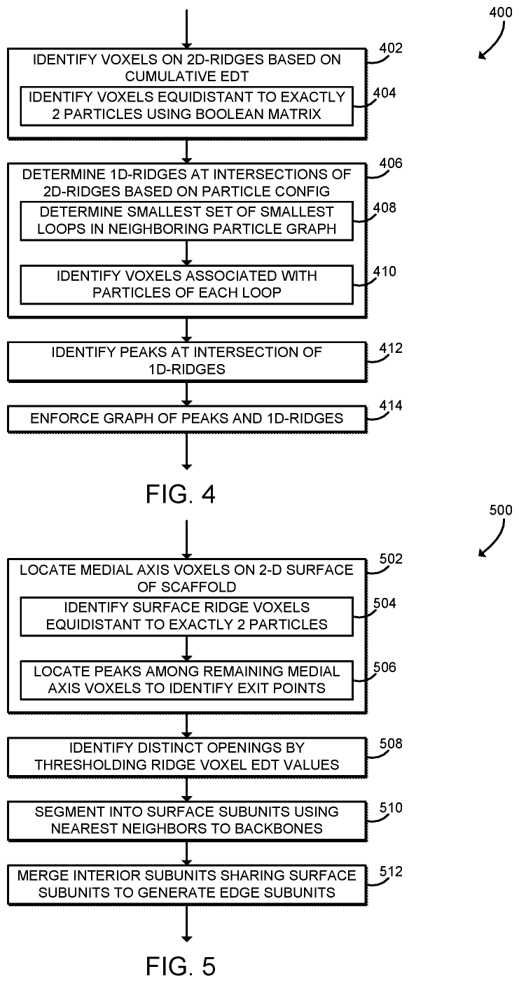

Referring back to FIG. 3, in block 314, the computing device 102 determines medial axis landmarks 214 for the void space based on the particle configuration 212 and/or the EDT 208. In some embodiments, in block 316 the computing device 102 may identify particular voxels that include 2D-ridges, 1D-ridges, and peaks. Elements of each medial axis subtype (2D-ridges, 1D-ridges, and peaks) may be uniquely defined by their equidistant particles. Briefly, 2D-ridges are surfaces (2-manifolds) including points (i.e., voxels) that are equidistant to precisely two particles, 1D-ridges are curves (1-manifolds) located at intersections of 2D-ridges, and peaks are points (0-manifolds) located at intersections of 1-D ridges. No voxel will be categorized as more than one medial axis type. The 2D- and 1D-tags refer to the surfaces (2-manifolds) and curves (1-manifolds), respectively, that are formed by these spatial landmarks in a 3-D domain, while the terms “ridge” and “peak” describe the qualitative look of the landmarks in a plot of 2-D EDT data. Each medial axis point (voxel) may be assigned an “ID” number that is related to its equidistant particles. This information can then be used to associate points that belong to the same unique element of a given subtype. One potential embodiment of a method for identifying medial axis landmarks 214 is described below in connection with FIG. 4.

In block 318, the computing device 102 segments the void space into subunits 224 based on the medial axis landmarks 214 and/or the EDT 208. In some embodiments, in block 320 the computing device may link multiple peaks on the medial axis to identify pockets of open space. By associating peaks that belong to the same open space, the computing device 102 avoids over-segmentation. Unlike classic segmentation approaches that use every local center point to uniquely define void space subunits (as in watershed), the computing device 102 forms subunits that can contain multiple center points. In this way, the disclosed segmentation approach captures the natural pockets of open space, where these pockets can be thought of as rooms (subunits) separated by doors. To identify which peaks belong to the same room, the computing device 102 may check if the physical distance between peaks is less than the sum of the their EDT values. The nonparametric nature of this approach only uses information about the space itself.

After determining an accurate representation of peaks connected by 1D-ridges, the computing device 102 clusters peaks that belong to the same open space. This is the first step toward removing doors in order to accurately segment the void space into natural pockets. To visualize this methodology, envision spheres centered at each peak with a radius equal to the peak's EDT value. For each pair of peaks, it is determined whether the physical distance between the sphere centers (peaks) is less than the sum of their radii (EDT values). Particularly, if d<r₁+r₂, where d is the Euclidean distance between p₁ and p₂, and r₁ and r₂ are the radii of p₁ and p₂, respectively, then p₁ and p₂ belong to the same open space. The peaks associated with overlapping spheres are then considered “connected,” and this data may be stored in a sparse peak-adjacency matrix.

The rationale for this approach can also be explained using the analogy of rooms and doors. To start, all peaks represent the center of distinct rooms, all 1D-ridges that connect peaks represent the hallways connecting them, and the minimum EDT along 1D-ridges represents the location of a door that separates each room. By definition, a peak point, p, is a distance, r, from multiple walls (particles) in the room. For p to be the sole center of the room, a sphere centered at p with radius r should not extend through any doors. If it does, the door is too massive for the space and should be knocked down to form one giant room.

Using the adjacency matrix of connected peak pairs, peak clusters of interconnected peaks may be formed using a breadth-first-search approach. The final clusters represent the peaks that lie within unique void space subunits.

In some embodiments, in block 322 the computing device 102 may form a backbone by clustering linked peaks with associated 1D-ridges. Sets of linked peaks are used to define unique subunits for void space segmentation and associated 1D-ridges of linked peaks form their backbone. With subunits currently defined by their peaks, the 1-manifold backbone of each subunit can be gathered. To start, the peak-1D-ridge key may be used to associate 1D-ridges to each subunit. If a 1D-ridge is flanked by two peaks that are part of the same subunit, the ridge will be entirely contained within the subunit, and therefore, the subunit's backbone will contain all of the ridge's voxels. This is also true if a subunit contains a peak that is associated with a 1D-ridge that extends to the edge of the void space. If a 1D-ridge contains an interior door, then the ridge is shared between two subunits and the correct portion of ridge voxels may be assigned to the correct subunit using the peak-1D-ridge key and 1D-ridge data.

For each subunit, the surrounding particles that enclose the pocket of space can be obtained by grabbing all equidistant particles associated with the peaks of the subunit. This information can be used to associate 2D-ridges to each subunit since 2D-ridges are defined by their two equidistant particles.

In some embodiments, in block 324 the computing device 102 may segment remaining void space with a nearest neighbor search. A nearest-neighbors algorithm applied to each backbone is used to complete the segmentation and form 3-D volumes of void space subunits. Unlike subunits derived from over-segmentation, the subunits capture the intrinsic pockets of empty space in the scaffold, which provides more useful subspace data for cell behavior studies. The backbone voxels of void space subunits are used to form the complete 3-D structure of the subunit by implementing a nearest neighbors algorithm. First, a variable is created containing the cumulative collection of all backbone voxels. Then, all non-backbone void space voxels are associated to their nearest backbone voxel, which then gets converted to the subunit identifying number that contains the voxel. With void space voxels distributed to their appropriate subunits, complete subunits are formed.

To obtain the single-voxel-thick edge (surface) of each subunit, an EDT within each subunit may be computed from the surrounding voxels using a threshold of mesh size multiplied by √2. A topographical map along the surface of the subunit that represents each point's distance from the center may be obtained, which can be used to study curvature. For each subunit, a “center backbone” is obtained, which comprises the subunit's peaks as well as any 1D-ridges that do not extend to the edge of the subunit. An EDT from the center backbone toward the surface voxels is computed. Points of higher elevation along the surface of the subunit will correspond to larger local values on the topographical map.

Referring now to FIG. 9, diagram 900 illustrates one potential embodiment of a subunit that may be determined through segmentation. The diagram 900 illustrates eight particles 902. A subunit 904 is defined in the void space between the particles 902. As shown, the subunit 904 represents the open space between particles 902 naturally and without overfitting.

Referring back to FIG. 3, in block 326, the computing device 102 merges one or more subunits 224 with segmented openings on the 2D surface of the scaffold. To track which subunits lie alone the edge of the void space, the computing device 102 may track which subunit contains voxels that intersect with the edge of the subunit. By merging subunits with segmented openings, the computing device 102 may capture true open pockets of space from all perspectives-both entering/exiting the scaffold as well as moving around the interior. Other segmentation approaches may extend void space segmentation boundaries to the surface of the void space, which may break apart the natural openings into the scaffold as viewed by an infiltrating cell. To address this, the 2D-surface of the void space is segmented as a separate entity, and then 2D-surface segmentation is combined with interior segmentation to form the final void space subunits. Including this step may isolate true 3-D pores as defined by open pockets of interconnected space separated by narrow channels. One potential embodiment of a method for segmenting the scaffold surface and merging subunits is described below in connection with FIG. 5.

In block 328, the computing device 102 generates one or more scaffold descriptors 230 based on the subunit segmentation 216. In some embodiments, in block 330, the computing device 102 may generate global descriptors, subunit descriptors, and non-subunit descriptors. A global descriptor is a single value that describes a scaffold, a subunit (pore) descriptor reports a distribution of measurements over each subunit in a scaffold, and a non-subunit descriptor is a distribution of measurements over non-subunit elements. In an illustrative embodiment, the computing device 102 may output 54 descriptors as indicated in Table 1 below. The descriptors of Table 1 are further organized by subcategories to motivate their utility. These motivations cover topics such as void space connectivity, subunit size, shape and directionality, ligand availability, and movement through the void space.

TABLE 1
Illustrative Scaffold Descriptors
Global Descriptors

| | |
|---|---|
| General | Number of particles |
| | Void volume fraction |
| | Average void area fraction |
| | Particle packing fraction |
| | Number of total subunits |
| | Number of interior subunits |
| | Max number of equidistant particles |
| Connectivity | Number of particle contacts |
| | Number of interior doors |
| | Subunit adjacency matrix eigenvalue |
| | Peak adjacency matrix eigenvalue |
| | Particle adjacency matrix eigenvalue |
| Entrance/Exits | Number of entrance/exit doors |
| | Max number of peaks among surface subunits |
| | Number of paths |
| Ligand Availability | Ligand hotspots volume fraction |

Subunit Descriptors

| | |
|---|---|
| Size | Volume (pL) |
| | Surface area (μm²/1000) |
| | Characteristic length (μm) |
| | Longest length (μm) |
| | Average internal diameter (μm) |
| | Aspect ratio (longest length/avg. internal diam |
| | Number of peaks |
| | Number of surrounding particles |
| | Largest enclosed sphere diameter (μm) |
| | Largest door diameter (μm) |
| | Smallest door diameter (μm) |
| Shape | Ellipsoid axis 1 length (μm) |
| | Ellipsoid axis 2 length (μm) |
| | Ellipsoid axis 3 length (μm) |
| | Mean local thickness (μm) |
| | Number of 2D-ridges |
| Directionality | Isotropy/Anisotropy |
| | x-, y-, z-centroid coordinate |
| Connectivity | Number of hallways (coordination number) |
| | Number of crawl spaces |
| | Number of surrounding subunits |
| | Normalized neighbors |
| Ligand availability | Ligand concentration (μmoles/L) |
| | Accessible ligand (μmoles) |

Non-subunit Descriptors

| | |
|---|---|
| Particles | Particle diameter (μm) |
| | Coordination number: neighboring particles |
| | Coordination number: touching particles |
| Connectivity | Entrance/Exit door diameter (μm) |
| | Interior door diameter (μm) |
| | Crawl space width (μm) |
| Paths | Path length (μm) |
| | Tortuosity-by-length |
| | Tortuosity-by-volume (pL) |
| Surface Subunits | Ligand concentration (μmoles/L) |
| | Accessible ligand (μmoles) |
| Accessible Regions | <1 μm object region volumes (pL) |
| | 10 μm object region volumes (pL) |
| | 30 μm object region volumes (pL) |
| | 60 μm object region volumes (pL) |

As inspiration for developing descriptors to address void space connectivity, cells are envisioned that are seeded within MAP scaffolds and that reside in the void space. These cells explore and traverse the space that is available to them without degrading the scaffold. Connectivity descriptors may study doors and hallways of packed rigid particles, where doors lie at partitions between subunits and hallways pass through doors along 1D-ridges, as well as the number of hallways per subunit, which is also referred to as the subunit's coordination number. The number of crawl spaces, which occurs between touching particles, refers to the number of 2D-ridges leaving the subunit. The number of surrounding subunits that share these 2D-ridges may be studied. Further, the descriptors include the eigenvalue of three adjacency matrices (particle, peak, and subunit) to provide more abstract descriptors of interconnectivity. The eigenvalue for each descriptor is bounded below by the average number of edges per node and bounded above by the maximum number of edges amongst all nodes.

The computing device 102 also outputs classic descriptors, such as volume and characteristic length; however, to address size restrictions, both the largest enclosed sphere as well as the largest and the smallest door per subunit may be output. An ellipsoid for each subunit may be approximated using principal component analysis (PCA). The length of the ellipsoid in each direction may be reported to understand the spread of the shape. To capture more topographical detail, mean local thickness for each subunit may be calculated, which is a measurement adapted from Hildebrand and Ruegsegger. Mean local thickness uses enclosed spheres within the subunit to assign local thickness measurements that are then averaged. A sphere of diameter d has a mean local thickness equal to d; however, a cube with height d has a mean local thickness that is less than d because local thickness decreases toward the corners of the cube, which brings down the average. Topographical complexity may be captured by reporting the number of 2D-ridges within a subunit, because the location of 2D-ridges correlates with the number of vertices (or tips) along the surface of the subunit. Since granular scaffolds may be utilized as tissue mimics, an isotropy/anisotropy measurement of void space that reflects the entire scaffold may be evaluated, similar to the way collagen fiber orientation is described for scar assessment. To do so, the relative orientation of each pocket of void space is studied, which uses eigenvectors from the subunit ellipsoids derived from PCA. The unitless isotropy-anisotropy descriptor ranges between 0 and 1, and a uniform distribution of the descriptor suggests anisotropy.

Describing the global descriptors, the number of particles is the total number of particles in the domain according to the “labeled particle” data. Void volume fraction is the ratio of void space voxels divided by all voxels contained within the convex hull. As a reminder, the void space is defined as the non-particle voxels contained within the convex hull of the particle centroids. For the void area fraction, a user-inputted value determines the number of evenly-spaced 2-D z-slices to sample within the middle two-thirds of the scaffold along the z-axis. A z-slice of the domain matrix is all rows (x) and all columns (y) along the specified page (z), and for each z-slice, the ratio of void voxels to all voxels within the convex hull is computed. The final void area fraction reports the mean across all z-slices. The number of total subunits is the number of interior subunits plus surface subunits in a scaffold. The number of entrance/exit doors is the total number of exterior doors, which is equivalent to the total number of edge (surface) peaks. The number of interior doors is the total number of interior doors, which are circles that lie between neighboring subunits that share a 1D-ridge (hallway). The number of paths is the total number of paths in a scaffold, where a path follows 1D-ridges from the center of the scaffold to an endpoint on the edge of the void space. The particle adjacency matrix is an N×N square Boolean matrix that is constructed using 2D-ridge data, where N is the number of particles and a value of true is stored at (i, j) when particle i and j are neighbors that share a 2D-ridge. The particle adjacency matrix max eigenvalue is the maximum eigenvalue of this matrix, which is bounded below by the average number of edges (2D-ridges) per node (particle) and bounded above by the maximum number of edges for a single node. The peak adjacency matrix is an N×N square Boolean matrix, where N is the number of peaks and a value of true is stored at (i, j) when peak i and j are part of the same subunit. Peak adjacency matrix max eigenvalue is the maximum eigenvalue of this matrix, which is bounded below by the average number of fellow peaks contained within a subunit and bounded above by the maximum number of fellow peaks associated with a single peak. The subunit adjacency matrix is an N×N square Boolean matrix, where N is the number of subunits and a value of true is stored at (i, j) when subunit i and j are neighbors that share a 1D-ridge (hallway, door). Subunit adjacency matrix max eigenvalue is the maximum eigenvalue of this matrix, which is bounded below by the average number of subunit neighbors and bounded above by the maximum number of neighbors for a single subunit in the scaffold. The max number peaks among edge subunits is the peak count of the edge subunit that contains the most number of peaks. Particle composition drastically influences the landscape of “edge” subunits of a scaffold. To capture an element of this phenomenon, the number of peaks contained within edge subunits is considered, since the number of peaks scales with the size and complexity of the subunit. The ligand hotspots volume fraction is the number of voxels that contain molecule counts above 2,167,200 divided by the number of voxels within the void space (convex hull). A ligand hotspot is defined as ≥2,167,200 ligand molecules, which is taken to be a constant. This value may be determined by taking 90% of the maximum ligand count of 2,408,000 molecules, seen in all ligand heatmaps. The ligand heatmap is a function of the mesh size (dx=2) and the ligand concentration (500 μmoles/L), both of which were consistent among all simulated domains. The maximum number of equidistant particles is determined for a given scaffold by searching for the peak that is equidistant to the most number of particles, and determining the particle count.

Describing the subunit descriptors, volume (pL) is determined by multiplying dx³ by the number of voxels that compose the subunit, then dividing by 1000 to report units of pL, where 1 pL=1 μm³. Surface area (μm²/1000) is determined by multiplying dx² by the number of edge voxels of the subunit, then dividing by 1000 to have comparable units to the Volume descriptor. The edge voxels of a subunit are the single-voxel-thick outer layer of the subunit. Characteristic length (μm) is determined as Volume (μm³) divided by Surface area (μm²). For reference, the characteristic length of a sphere with radius r is r/3, while a cube with height h is h/6. Longest length (μm) of a subunit is the maximum spanning distance across edge voxels. For average internal diameter (μm), locate the narrowest point along 1D-ridges that are entirely contained within the subunit and report the average diameter (using EDT values) at these points. For subunits that contain a single peak, the average internal diameter is equal to the diameter of the largest enclosed sphere. The aspect ratio may be reported which looks at the ratio of longest length and average internal diameter. The number of surrounding particles is the number of particles that enclose the subunit. The number of hallways for each subunit is how many 1D-ridges are shared with neighboring subunits. This descriptor is equivalent to the number of doors that separate a subunit from its neighboring subunits. The number of crawl spaces for a subunit is how many 2D-ridges exit the subunit, while the number of surrounding subunits for a sububit is how many neighboring subunits share 2D-ridges with the subunit. The normalized neighbors is the number of hallways divided by the number of surrounding subunits. The mean local thickness is the integral of local thickness over the subunit divided by the volume of the subunit. A thickness matrix per subunit is constructed that assigns a “thickness” value to each voxel in the subunit. To obtain thickness values for a given subunit, all 2D-ridge voxels that are contained within the boundary of the subunit are identified. The thickness matrix at these 2D-ridge voxels are set to their EDT value multiplied by 2, and the remaining voxels are initialized to zero. For each 2D-ridge voxel, vᵢ, within the subunit, the distance between vᵢ and all other subunit voxels is computed in order to identify the subunit voxels, {sᵢ}, that lie within a sphere centered at vᵢ with radius equal to the EDT value at vᵢ. The thickness values for voxels in {sᵢ} are updated to equal the maximum between their current value and the EDT of vᵢ multiplied by 2 (i.e., diameter of the sphere). The number of peaks is the number of peaks associated with a given subunit. The largest enclosed sphere diameter (μm) is determined by identifying the peak associated with the largest EDT value and reporting this EDT value multiplied by 2. The largest and smallest door diameters (μm) are the diameter of the largest and smallest door associated with the subunit, respectively. A “door” is a circle that represents the boundary of one subunit from a neighboring subunit. The ellipsoid axis 1, 2, and 3 lengths (μm) are the length of the first, second, and third principal axis of each PCA ellipsoid. For each subunit, principle component analysis (PCA) is performed to approximate the spread of the subunit with an ellipsoid. To do this, the covariance matrix is computed from the subunit's voxel coordinates and its three orthogonal eigenvectors and associated eigenvalues are determined. The eigenvectors represent the principle directions of spread, while the eigenvalues describe the intensity of the spread in each direction. The isotropy/anisotropy descriptor measures the deviation of ellipsoid i from e_{avg}. First, the unit eigenvector associated with the largest eigenvalue (major axis, first principal direction) is averaged across all PCA ellipsoids, then the result is normalized. This produces the average direction, e_{avg}, across all subunits. Then, for a given subunit i, |e_{avg}·eᵢ| is computed, where eᵢ is the major axis direction of PCA ellipsoid i. The (x, y, z) coordinate of the subunit's centroid may also be reported. The ligand concentration (μmoles/L) descriptor represents the average ligand concentration within a subunit as sensed by a migrating object. For a given subunit, the values of the ligand heatmap are summed that correspond to the voxels of the subunit, then divided by the volume of the subunit. The value is converted to pmoles/L using 1 μm³=10⁻¹⁵ L and 1 μmole=6.02×1017 molecules. The accessible ligand (μmoles) descriptor represents the amount of ligand that is accessible to an object inside of the subunit. First the particle voxels that enclose the subunit are located by checking for which subunit voxels neighbor a particle voxel. The total count of these voxels is then converted to a surface area, which is then multiplied by the user-inputted value representing how far into a particle a cell can reach (shell thickness). This volume is then converted into pmoles of ligand using a ligand concentration of 500 μmoles/L and a conversion of 1 μm³=10⁻¹⁵ L.

Describing the non-subunit descriptors, particle diameter (μm) is, for each particle, the diameter of a sphere with equivalent volume. Particle coordination numbers for a given particle refer to the number of neighboring particles that either 1) share a 2D-ridge with the particle, or 2) are physically touching the particle (which is a subset of the first category). The entrance/exit door diameter (μm) is the diameter of each entrance/exit doors of a scaffold, which are circles on the 2D-surface edge of the void space that are centered at peaks and extend to equidistant particles. The internal door diameter (μm) is the diameter of each of the internal doors of the scaffold, which are circles centered at peaks of the void space that extend to the peak's equidistant particles. The crawl space width (μm) corresponds to the physical distances between particles that share a 2D-ridge. The path length (μm) is the length of a path, which is the shortest cumulative distance along 1D-ridges from the center of the scaffold to the edge. The lengths of the 1D-ridge segments that make up the path may be summed. The arc length of each 1D-ridge may be computed by approximating 1D-ridges using least squares splines. Tortuosity-by-length is, for each path, the classic arc-chord ratio. The arc length is the “path length” descriptor; the chord length is the end-to-end distance between the start of the path (“center” peak of the scaffold) and the end of the path (either an edge-peak or the endpoint of an edge-ridge). Tortuosity-by-volume (pL) is determined by using numerical methods (e.g., MATLAB methods) to compute the volume of the 3-D convex hull of all path voxels. The Surface ligand concentration (μmoles/μm²) represents the ligand concentration that is sensed by an infiltrating object along the 2-D surface of a scaffold opening. For each 2-D surface subunit, values in the ligand heatmap may be summed that correspond to voxels of the subunit and converted to micromoles using a conversion of 1 μmole=6.02×1017 molecules. This value is divided by the surface area of the subunit. The surface accessible ligand (μmoles) descriptor represents the amount of ligand that is accessible to an infiltrating object along the 2-D surface of each scaffold opening. For each 2-D surface subunit, the particle voxels that surround the subunit are located by checking which subunit voxels neighbor a particle voxel. The total count of these voxels is then converted to a surface area, which is then multiplied by the user-inputted value representing how far into a particle a cell can reach (shell thickness). This volume is then converted into μmoles of ligand using a ligand concentration of 500 μmoles/L and a conversion of 1 μm³=10⁻¹⁵ L. Available regions data (pL) isolates all distinct regions of the void space through which an object can fit. Four illustrative object “species” are selected that are represented as spheres of varying size: <1 μm, 10 μm, 30 μm, and 60 μm diameter spheres. <1 μm objects are on the size-scale of molecules; 10 μm objects are akin to cells. 30 μm objects are like 3-cell clusters, and 60 μm objects are like 6-cell clusters. For each species size category, the computing device 102 locates the 1-manifold backbone voxels associated with an EDT value that is greater than or equal to the radius of the object. A connected components approach is then used to isolate unique islands of backbone clusters. For the smallest category, the EDT threshold is set to 0, and the largest island is located to define the main backbone of the scaffold. All voxels not connected to this main backbone are not considered in analysis for any species category. Once the backbone of distinct regions through which the species can fit is identified, the remaining void space voxels associated with each region are gathered. For each region, each voxel, v_{b}, of the backbone is scanned, and the void space voxels whose distance to v_{b} is less than the EDT value at v_{b} are gathered. This cumulative collection of void space voxels forms the complete regions. Finally, the volume of each region is computed.

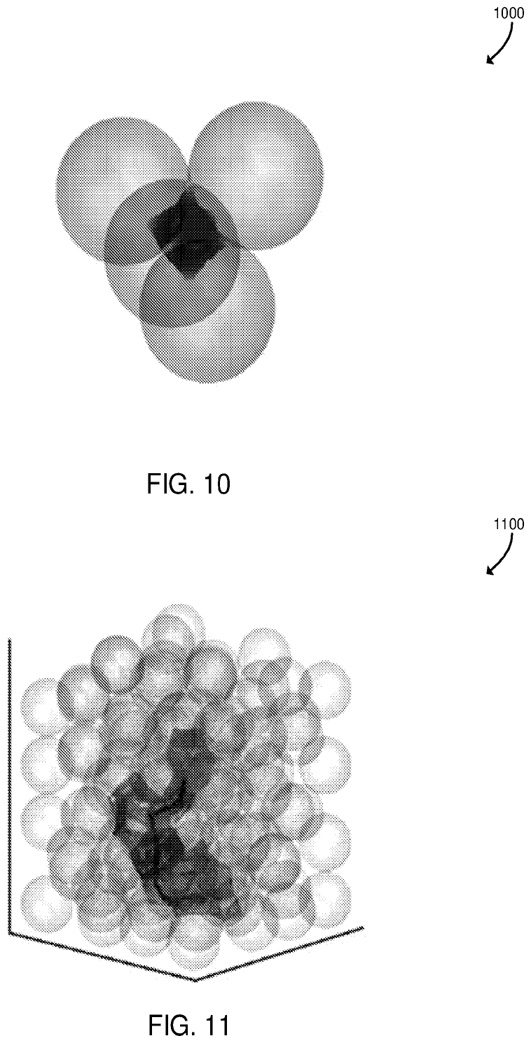

In block 332, the computing device analyzes the segmentation 216 and the scaffold descriptors 230. For example, animation software may be used to generate simulated granular scaffolds that comprise more sophisticated particles than standard spheres, such as soft-body particles, rough particles, and non-spherical particles. This simulation and animation data can be used to visualize 3-D pores and characterization metrics. These images may be important for data visualization and science communication. Further analysis techniques and metrics are described further below in connection with FIGS. 10-12. After analyzing the segmentation and/or scaffold descriptors, the method 300 loops back to block 302, in which additional input data 204 may be processed and analyzed.

Referring now to FIG. 4, in use, a computing device 102 may execute a method 400 for determining medial axis landmarks. In some embodiments, the method 400 may be executed in connection with block 314 of FIG. 3, described above. It should be appreciated that, in some embodiments, the operations of the method 400 may be performed by one or more components of the environment 200 of the computing device 102 as shown in FIG. 2. The method 400 begins with block 402, in which the computing device 102 identifies voxels within the void space that are located on 2D-ridges based on the cumulative EDT 208. In block 404, the computing device 102 identifies voxels that are equidistance to exactly 2 particles using a sparse Boolean matrix. To locate 2D-ridge voxels, the computing device 102 searches for medial axis voxels that are equidistant to exactly two particles. Unique 2D-ridges are identified by their equidistant particles, and the computing device 102 stores their indices and particle pairs. This information may also be used to generate a sparse particle-adjacency matrix, a neighboring particle graph, or otherwise determine the particle configuration 212.

In block 406, the computing device 102 identifies voxels located on 1D-ridges, which are located at intersections of 2D-ridges, based on data included in the particle configuration 212. Accordingly, the existence of each unique 1D-ridge may be determined based on the particle configuration 212 alone, and then a search may be performed for the voxels associated with the 1D-ridges (top-down approach). In block 408, the computing device 102 determines a smallest set of smallest loops in the neighboring particle graph 212. This set of particle loops defines all unique 1D-ridges in the scaffold, which means that all 1D-ridges can be identified according to the particle configuration 212. Accordingly, this approach is independent from the grid of the scaffold domain.

Referring now to FIG. 7, diagram 700 illustrates one potential embodiment of medial axis landmarks. The diagram 700 illustrates three particles 702, 704, 706. The diagram 700 also illustrates three 2D-ridges 708, 710, 712. The 2D-ridge 708 is equidistant from the particles 702, 704, the 2D-ridge 710 is equidistant from the particles 704, 706, and the 2D-ridge 712 is equidistant from the particles 702, 706. As shown, the 2D-ridges 708, 710, 712 intersect at 1D-ridge 714. The diagram 700 further illustrates a sample loop 716, which defines the ridge 714 that is equidistant to particles 702, 704, 706. These points are assigned the unique ID number (702, 704, 706), which defines this 1D-ridge. The method for finding the set of smallest loops is adapted from the approach by Lee et al. (Joon Lee, C., Kang, Y.-M., Cho, K.-H. & No, K. T. A robust method for searching the smallest set of smallest rings with a path-included distance matrix. PNAS 106, 17355-17358 (2009), but with modification. The published method is specifically meant for planar graphs, which takes advantage of the fact that it is known exactly how many loops will exist. Since the neighboring particle graph is not planar, it cannot be assumed that the number of loops will be known a priori.

Naively feeding the entire neighboring-particles graph into the method may become extremely computationally expensive. In some embodiments, the problem of finding the entire set of smallest loops may be decomposed into a number of sub-problems: for each node (or particle) i of the graph, find the set of smallest loops that all contain node i. Then, to solve these sub-problems efficiently, the computing device 102 exploits the fact that the voxels along the 1-manifold backbone of the scaffold, i.e., voxels that have at least three equidistant particles have already been identified. Information about equidistant particles provides hints as to which nodes should be included in the sub-graph for each sub-problem. Then, solving each sub-problem for every node of the graph effectively solves the original larger problem.

It is not guaranteed that solving the collection of sub-problems will always be faster than solving the larger problem as a whole, but intuitively, it makes sense that it is much more performant. Attempting to solve the larger problem on the entire graph may require exhaustively searches for loops in an O(n³) fashion, where n is the number of nodes; however, many node combinations that are visited by the algorithm aren't even spatially close to one another. On the other hand, each of the sub-problems solved by the computing device 102 only constructs loops among nodes (or particles) that are known to be close to one another, thanks to the information provided by the 1-manifold backbone voxels.

Referring again to FIG. 4, in block 410, the computing device 102 identifies voxels associated with the particles of each smallest loop. Once the set of smallest loops of the neighboring-particles graph has been found, this information is used to classify disjoint subsets of the medial axis voxels as 1D-ridges. The criteria for creating such subsets may be: voxels form a 1D-ridge if their set of equidistant particles (1) match each other, and (2) match a loop found earlier. Accordingly, not all 1-manifold backbone voxels will be assigned to a 1D-ridge. These voxels will later be considered as candidates for peaks.

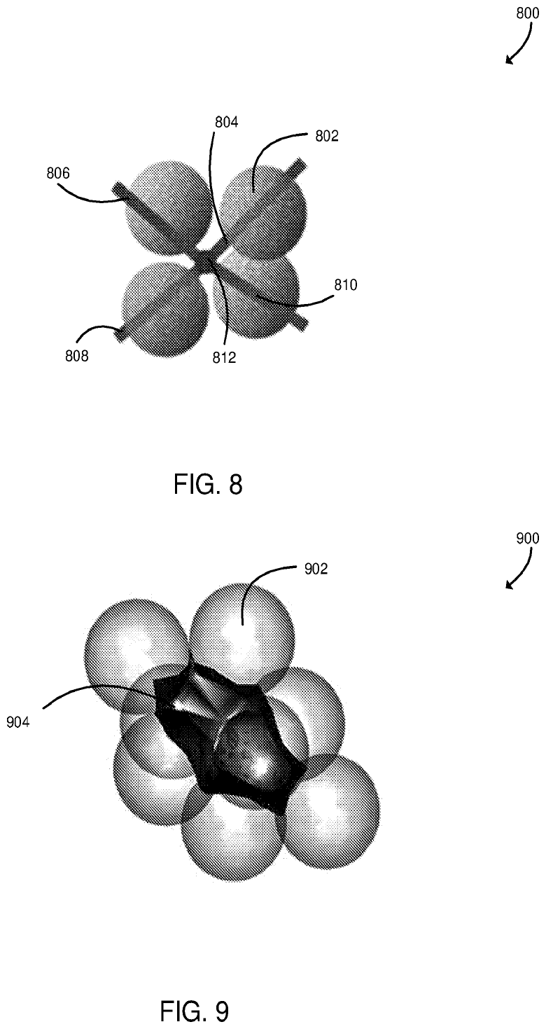

In block 412, the computing device 102 identifies voxels located at peaks, which are located at intersections of 1D-ridges. Referring now to FIG. 8, diagram 800 illustrates another potential embodiment of medial axis landmarks. The diagram 800 includes four particles 802, which are not individually labeled. The diagram 800 includes four 1D-ridges 804, 806, 808, 810, which may be determined as described above. The 1D-ridges 804, 806, 808, 810 intersect at peak 812.

Like 1D-ridges, unique peaks are defined by their equidistant particles. Locations for the peaks may be determined by mining the remaining medial axis voxels that were not assigned to 2D-ridges or 1D-ridges. As a brief overview, the remaining voxels are clustered using a connected components approach. For each cluster, voxels that are equidistant to the greatest number of particles are identified, since those voxels may better reflect the location of the true peak. For example, one cluster may contain voxels A={vᵢ₁, . . . , vᵢₙ} that are equidistant to four particles and voxels B={vⱼ₁, . . . , vⱼₘ} that are equidistant to five particles. The maximum EDT value among B is located and the corresponding voxel Bₘₐₓ is labeled as a peak that is defined by its five neighboring particles. The remaining voxels in A and B are distributed to the appropriate 1D-ridges. The peaks and 1D-ridge data may be then forced to fit the definition of a graph, which ensures that the final results accurately capture the landscape of the void space even though the data has been constrained to a discretized grid.

For a more detailed explanation: The first pass involves clustering the remaining voxels that share the same particle neighbors, as this will begin to isolate unique peaks. From the initial set of medial axis voxels, first all voxels are removed that have been assigned to 2D- or 1D-ridges. Next any remaining voxels are removed that are equidistant to exactly three particles because, while these voxels are not assigned to a 1D-ridge, they are in fact associated with 1D-ridges that extend to the edge and whose third 2D-ridge (1D-ridges are formed from intersections of 2D-ridges) lies outside of the void space. These 1D-ridges are ignored. At this stage, voxels are scanned looking for matching sets of equidistant particles. Once the initial clustering process is complete, if any cluster cᵢ contains voxels that are equidistant to a subset of particles from another cluster cⱼ, then cᵢ will not contain a true peak. Therefore, all voxels from cᵢ must be “moved” to the appropriate 1D-ridge according to their nearest particles. Now, for each remaining clusters, we identify the voxel associated with the largest EDT value to generate our initial set of true peaks. Remaining voxels are moved to the appropriate 1D-ridges.

In a second pass, peaks that are physically touching are located by using a connected components clustering algorithm. For any cluster containing more than a single voxel, the voxel with the largest EDT is selected and the remaining voxels are moved to 1D-ridges. Such neighboring peaks indicate that the resolution of the grid cannot resolve the ridge between the peaks, and therefore, it is reasonable to approximate them as a single peak. The selected peak also adopts any new equidistant particles associated with the peaks that were not selected. Therefore, this process creates a new peak, as defined by its set of equidistant particles, and a second round of checking must be performed to determine whether any peaks are associated with equidistant particles that are a subset of another peak's equidistant particles.

Referring again to FIG. 4, in block 414, the computing device 102 may enforce graph rules for peaks and 1D-ridges. The graph of peaks and 1D-ridges should comprise interior 1D-ridges that are flanked by a single peak on either end. In addition, all 1D-ridges that extend to the edge of the void space should be flanked by a single peak at the interior end. There are also scenarios where 1D-ridges span two edges of the void space, in which case they are not associated with any peaks. Peaks and 1D-ridge “keys” may be stored that document which 1D-ridges are associated with which peaks, and vice versa. To generate these associations, the computing device 102 again looks for equidistant particles of 1D-ridges that are subsets of equidistant particles of peaks. Peaks lie at intersections of 1D-ridges, therefore peak equidistant particles should always be parents of 1D-ridge equidistant particles.

During development, it was found that domains with a low resolution relative to particle size, e.g., 40 μm diameter particles with a dx=2 μm, sometimes produced incorrect initial peak-1D-ridge associations that did not fit the definition of a graph. These scenarios were unpredictable and required case-specific code to resolve, as described further below.

The doors inside of a scaffold are the partition points that delineate open pockets of void space. Interior doors are represented as circles that are centered near the narrowest point along their respective 1D-ridges and extend to equidistant particles. First, “doors” are located along all 1D-ridges, and then later the doors that physically lie within open pockets of space as opposed to differentiating them are removed. To find the narrowest point along a 1D-ridge, the computing device 102 searches for the voxel along the ridge that has the smallest EDT value, vₘᵢₙ. In the case where multiple voxels tie, the voxel closest to the average location is chosen. The three closest particles to the 1D-ridge are then identified, and for each particle, the particle voxel, vᵢ, is located that lies closest to vₘᵢₙ. The door is then generated by fitting a circle to v₁, v₂, and v₃.

Since each 1D-ridge contains a door at vₘᵢₙ, ridge voxels that lie on either side of the door can be partitioned using the normal vector to the plane containing the circle. For each 1D-ridge, four pieces of information may be stored in a cell array: 1) the index of the peak(s) associated with the end of the ridge that lies in the first room, 2) the indices of the ridge voxels that lie within the first room, 3) the index of the peak(s) associated with the end of the ridge that lies in the second room, and 4) the indices of the ridge voxels that lie within the second room. The accuracy of this cell array indicates where to resolve discrepancies in the graph.

To ensure that every interior 1D-ridge is flanked by a single peak on either end, the computing device 102 first scans for interior 1D-ridges that are associated with two or more peaks on one end and zero peaks on the other. In these situations, if there are more than two peaks, the peak that is farthest from the rest is assigned to the other end. If there are two peaks, the peak that is closest to the door is moved.

The computing device 102 next checks for any remaining interior 1D-ridges that are associated with multiple peaks on at least one end. In these situations, the aim is to reduce to a single peak by conceptually “combining” peaks when appropriate, which amounts to removing voxels from the list of true peaks. For the end of the 1D-ridge that contains multiple peaks, all combinations of peak pairs are scanned to check whether they flank another 1D-ridge. For peaks that do flank another ridge, these peaks are not removed from the list of true peaks. Instead, the association of the less accurate peaks with the current 1D-ridge is removed. For peaks that do not flank another ridge, it is determined whether they are physically close by observing whether the Euclidean distance between them is less than the sum of their EDT values. If they are far apart, again the association of the less accurate peaks with the current 1D-ridge is removed. If they are close, then the peaks can be ‘combined’ by selecting the most accurate peak and removing the others from the list of true peaks. The most accurate peak is determined to be the one that is either farthest from the peak on the opposite end (if it exists) or farthest from the door along the 1D-ridge. All keys and variables containing information about the peaks-1D-ridge graph are then updated.

After removing excessive peak associations, there are checks for situations where peaks are missing. The computing device 102 scans for interior 1D-ridges that are flanked by less than two peaks. If an interior ridge is flanked by a single peak that otherwise fulfills the definition of the graph (i.e., all other interior 1D-ridges associated with the peak are flanked by two peaks), then it oftentimes consists of only one or two voxels because the resolution of the grid is too small. Therefore, it is acceptable to remove the ridge from the graph. In all other cases, an appropriate peak is search for to assign to the missing end of the 1D-ridge. First, the list of prospective peaks is narrowed down by locating peaks that surround the ridge. To do this, a search is performed for peaks whose set of equidistant particles comprises N−1 of the N equidistant particles of the 1D-ridge. Then for each peak, anew variable is created that contains the peak's equidistant particles as well as its next-nearest particle. If this new variable contains all of the ridge's equidistant particles, it is considered as a prospective peak. If no such peaks exist, then it is reasonable to remove the ridge as opposed to select a new peak from the grid because the ridge is too small for the resolution of the grid. How to move forward with the list of prospective peaks, {pᵢ}, depends on the 1D-ridge.

If the ridge in question comprises a single voxel and the length of {pᵢ} is greater than the number of missing peaks, then the prospective peaks that are physically closest to the ridge voxel are chosen. If the length of {pᵢ} is equal to the number of missing peaks, then {pᵢ} is assigned to the 1D-ridge. If the length of {pᵢ} is less than the number of missing peaks, then the ridge is removed instead of selecting a new peak from the grid.

If the 1D-ridge comprises multiple voxels and there is a single missing peak, then the first aim is to find the best next-nearest particle that we can associate with the 1D-ridge in order to help narrow down the best peak. As a reminder, each voxel of the 1D-ridge is, by definition, equidistant to the same set of particles. However, each voxel's next-nearest particle may be different. The computing device 102 looks for the voxel that “behaves” the most like a peak and uses that voxel's next-nearest particle to associate with the 1D-ridge. By “behave” like a peak, it is meant that the voxel is nearly equidistant to its next-nearest particle. The voxel should also be near the end of the ridge that is missing the peak. If there are ridge voxels on either side of the door, then is only needed to check the ridge voxels on the side of the door that contains the missing peak. If all 1D-ridge voxels exist on one side of the door and the other side is empty, then the ridge voxel that is physically farthest from the existing peak is used as a marker for the side with the missing peak. The computing device 102 then looks for the ridge voxel that has the shortest distance to its next-nearest particle while also lying closer to the marker compared to the existing peak. Once this ridge voxel is identified, its next-nearest particle is added to a new variable, b, that also contains the 1D-ridge's equidistant particles. Now, {pᵢ} can be scanned to find the peak that has the most overlapping particles with b. If there is a single winner, store the peak, p_{w}, for later use. If there are ties, follow the same procedure as above for combining peaks. First, scan all combinations of peak pairs to check whether they flank another 1D-ridge. If they do not, confirm the peaks are physically close using the same threshold, then “combine” peaks by selecting the peak with the largest EDT value. The remaining peaks are converted to voxels on the 1D-ridges to which they were previously associated, and all related variables and keys are updated. If multiple potential peaks are left, the peak, p_{w}, that is closest to the end of the 1D-ridge that is missing the peak is chosen. Otherwise, the single peak, p_{w} is stored. At this stage, the missing peak, p_{w} is determined; however, a final check may be performed to see if the pair of peaks (p_{w} and the existing peak) already flank another 1D-ridge. If so, the current ridge is removed. This last step is one example of an unpredictable outcome that required a case-specific piece of code to resolve.

If the interior 1D-ridge comprises multiple voxels and both peaks are missing, similar steps are followed as the single-missing-peak case. The distances to the next-nearest particles for all voxels in the 1D-ridge are grabbed and sorted; however, the next-nearest particle of the voxel associated with the shortest distance is immediately stored. It is also tracked which end of the ridge this voxel lies.

For the case of a 1D-ridge where all of its voxels exist on one side of the door and the other side is empty, the voxel associated with the shortest distance is used as a marker for one end of the ridge and similar steps are proceeded with as above. After finding a next-nearest particle associated with a voxel on each end of the ridge, the steps outlined above are repeated twice, treating each end of the ridge as a separate case. Again, all keys and variables are updated where appropriate.

In some instances, it was found that a true peak lies at the precise intersection between two or more voxels, resulting in multiple voxels that are flagged as peaks, while the true peak lies off of the grid. It was found that these situations arise when peaks are associated with two or fewer 1D-ridges, so these peaks may searched for using the peaks-1D-ridge key. Once found, the peaks that share at least N−1 equidistant particles are clustered, where N is the max number of equidistant particles in a cluster. For each cluster, the peak associated with the largest EDT value is selected, and all keys and variables are updated accordingly.

Referring now to FIG. 5, in use, a computing device 102 may execute a method 500 for surface opening segmentation and merging. In some embodiments, the method 500 may be executed in connection with block 326 of FIG. 3, described above. It should be appreciated that, in some embodiments, the operations of the method 500 may be performed by one or more components of the environment 200 of the computing device 102 as shown in FIG. 2. The method 500 begins with block 502, in which the computing device 102 locates medial axis voxels on the 2-D surface of the scaffold. To study the openings of the scaffold, consider the edge of the void space as a 2-D surface living in 3-D space-like the peel of an orange. The computing device 102 computes the EDT of the convex hull and uses a threshold cutoff of mesh size multiplied by 2 to identify the single-voxel-thick edge. Then, the edge is intersected with void space voxels to identify the surface of the void space and with particle edge voxels to determine the particle boundaries that lie within the 2-D surface. To locate medial axis voxels along the 2-D surface, the computing device 102 applies the surface data toward the same methodology described above for 3-D space. In 2-D space, medial axis landmarks include two types: surface ridges and edge peaks. Surface ridge voxels are located by searching for medial axis voxels that are equidistant to exactly two particles. Surface peaks are located using a straightforward approach appropriate for lower dimensional space. For the remaining medial axis voxels, a connected components algorithm is applied, under the assumption that each cluster will contain a unique peak. For each cluster, the peak is identified as the voxel associated with the largest EDT value. The remaining voxels are labeled as ridge voxels. In block 504, the computing device 102 identifies surface ridge voxels that are equidistant to exactly 2 particles. In block 506, the computing device locates peaks among the remaining medial axis voxels to identify exit points.

In block 508, the computing device 102 identifies distinct openings by thresholding ridge voxel EDT values. In block 510, the computing device 102 segments surface voxels into surface subunits using nearest neighbors to backbones. An alternative approach for segmenting the surface of the void space relies on a user-inputted threshold for defining the maximum diameter of a hallway. All ridge voxels that lie below the threshold are removed, and a connected components algorithm is applied to the remaining ridge voxels and peak voxels to form islands that serve as the 1-manifold backbone of distinct rooms. The remaining surface void voxels are then associated to the nearest room backbone by computing an EDT of surface voxels to islands and using the closest-pixel map, which forms the final 2-D surface subunits. Exterior doors are represented as the circles centered at surface peaks extending to the equidistant particles with radius equal to the EDT at the peak. Therefore, for each peak, plotting these doors requires locating the nearest voxels on three equidistant particles and fitting a circle.

In block 512, the computing device 102 merges interior subunits sharing surface subunits to generate edge subunits. To create accurate void space subunits that capture open regions of space from all perspectives, interior subunits that share the same 2-D surface open space are merged. For each interior subunit that lies on the edge of the void space, a search is performed for all 2-D surface subunits whose voxels intersect with edge voxels of the interior subunit. Then, interior subunits that share common 2-D surface subunits are grouped and all of their voxels are pooled to form new “edge subunits.” For these new subunits, all subunit data is updated, such as 2D-ridges, 1D-ridges, surface peaks, interior peaks, backbone, doors, surrounding particles, etc., as well as the single-voxel thick edge of the subunit is recomputed. If any edge subunit is not associated with a surface peak, it is removed from the list. Such a situation might arise when a single edge voxel, e.g., the tip of a vertex on an interior subunit intersects with the edge of the void space. A Boolean vector is created to indicate which subunits are edge subunits. Sparse adjacency matrices are also created to serve as quick look-ups for subunit data. For example, a Boolean matrix may be used to store adjacent subunits that share 2D-ridges, and an adjacency matrix for subunits that share a 1D-ridge may be created, where the values in the matrix represent the diameter of the door connecting them.

### EXAMPLES

As an example, a library of packed particle “standards” was be generated to be used as a reference in the field, boasting over 60 scaffolds types and over 400 descriptor data plots comparing them. The illustrative library includes scaffolds comprising random-packing of monodisperse rigid spheres, bidisperse rigid spheres, polydisperse rigid spheres, monodisperse soft-body spheres, bidisperse mixtures of rigid and soft-body spheres, non-smooth spheres, and non-spherical particles, as well as square and hexagonal perfect-packing to serve as controls. To accompany the data library, sample images are provided of different simulated scaffolds and their corresponding subunits, which helps users to appreciate the variation in 3-D pore size and shape that accompanies changes in particle composition. Cumulatively, the library plots contain descriptor data from over 550 particle domains and serve as an easy look-up. This library of standards is a resource for granular scaffold engineers and others developing improved scaffolds.

Referring now to FIG. 10, schematic diagram 1000 illustrates experimental results that may be achieved by the system 100. Granular scaffolds often comprise particles that are designed with surface ligands to attract cells, so experimental data was used to assign ligand molecules to particle shells. For each void space subunit, particle surfaces that enclose the pocket of space were located to compute “accessible ligand” (in μmoles) per subunit. This value was also computed for the openings into and out of the scaffold. Next, a ligand heatmap was created by using an averaging filter in order to mimic the average number of ligand molecules sensed by a migrating 10 μm spherical cell. One example of such a ligand heatmap is shown in the diagram 1000. These results allow for computation of the volume fraction of ligand “hotspots” within the scaffold, as well as the ligand concentration (in μmoles/L) per subunit and per scaffold opening that is sensed by residing and infiltrating cells, respectively.

To study ligand availability, the surface of particles are labeled with ligand, and a ligand heatmap is produced on the domain that aims to reflect the average number of molecules sensed by a migrating cell. To start, the following parameters are initialized: ligand concentration, particle shell thickness, and cell diameter. In an experiment, a hydrogel microparticle (HMP) ligand concentration of 500 μmoles/L was chosen based on experimental data. Shell thickness refers to how far into an HMP a cell can reach or sense ligand, which was set to 4 μm. Cell diameter was set to 10 μm. Using ligand concentration and the conversions 1 μm³=10⁻¹⁵ L and 1 μmole=6.02×10¹⁷ molecules, the number of ligand molecules per voxel was computed, and this value was assigned to the shell voxels of each particle. To generate the heatmap, an average pooling convolution was performed on the domain using a spherical window with diameter equal to cell diameter. It was noticed that cropped particles contained artificial shell voxels along the face of the crop, which led to an artificial increase in the number of ligand molecules per particle. This issue was avoided by cropping the top of the ligand map by the shell thickness and using a cropped version of the domain for computations that use the ligand map.

In another example, paths through a domain for various particle sizes may be determined. Referring now to FIG. 11, diagram 1100 illustrates additional experimental results that may be achieved with the system 100. A path may be defined as the shortest distance along 1D-ridges from the center of the scaffold to the edge of the void space. The starting point for all paths is the peak lying closest to the center of the domain. Paths either end at 1D-ridges that extend to the edge of the void space (edge-ridges) or at peaks that intersect the edge of the void space (edge-peaks). In an experiment, to take advantage of native MATLAB methods, a graph object, g, was created, where peaks serve as nodes and 1D-ridges serve as edges connecting them. End-nodes are nodes that serve as markers for the end of a unique path in g. Edge-peaks are end-nodes; however, edge-ridges are not included in g, so we store their associated peaks as end-nodes.

In order to determine the shortest path from the domain center to each edge point, the length of each 1D-ridge is computed and stored. The experiment started by approximating each 1D-ridge with a least squares spline by fitting the x-, y-, and z-components of the ridge voxels with separate splines. To do this, each component must be parameterized with respect to a separate independent variable; namely, the aim is to fit splines to the data point (rᵢ, xᵢ) for all i, (sᵢ, yᵢ) for all i, and (tᵢ, zᵢ) for all i, where r, s, and t are the different independent variables for each component. However, the order of the data points with respect to the parameterization need not match their order in physical space, so a proper spatial ordering must first be imposed on the data points. To this end, an ordering is derived by placing a theoretical heat source at the peak on one end of the 1D-ridge, and then allowing the heat to diffuse across the graph induced by the ridge voxels, where edges exist between neighboring ridge voxels. After one diffusion solve, the value of the heat at each voxel indicates exactly how far it was from the heat source, which produces an ordering of the ridge voxels. For 1D-ridges that are not flanked by any peaks, the ridge voxel that intersects with the edge of the void space is selected. If no such voxel exists, then the first voxel in the list of ridge voxels is selected since this usually corresponds to one end of the ridge. Once the spline is fit to the 1D-ridge, the arc length is computed to obtain the length of the ridge.

Once 1D-ridge lengths are assigned to the edges of g, the shortest path from the center peak to each end-node is obtained using MATLAB methods for graph objects. For end-nodes that refer to peaks connected to edge-ridges, a unique path for each edge-ridge is created, and the lengths of these ridges are added to their final path length. Since these paths are not flanked by peaks, the edge-ridge voxel that represents the outer ‘end’ of the path is also stored in order to compute the path's end-to-end (chord) length, which is used in the classic definition of tortuosity. To locate this voxel, look for the edge-ridge voxel that intersects the edge of the void space. If none exists, the edge-ridge voxel that is physically farthest from its peak is selected.

As another example, it was considered how the size of an object impacts where it can travel within the void space. Four spherical object species of varying diameters were studied: molecules (<1 μm), cells (10 μm), 3-cell clusters (30 μm), and 6-cell clusters (60 μm). For each object, all distinct regions of the void space where the object can fit were mapped out. An object cannot move between regions, and as an object becomes larger, the available regions become increasingly disjoint and sparse. To capture this phenomenon, the volume of each region of space that can contain the object is determined. Lastly, to study available routes for an infiltrating object or flow through the scaffold, a path is defined as the shortest route along the 1D-ridge backbone from the center of the scaffold to an entrance-exit door, as described above. By computing paths to each entrance, path descriptors that include path length may be produced, as well as two measurements of tortuosity. Tortuosity-by-length refers to the arc-chord ratio, the simplest definition of tortuosity, while tortuosity-by-volume refers to the volume of the convex hull containing the set of path points. Unlike arc-chord ratio, a volume-based approach for describing tortuosity will scale with path size.

As yet another example, in the context of granular scaffolds, “pores” refer to the open pockets of space throughout the scaffold. The computing device 102 provides a deterministic approach for extracting 3-D pores, i.e., subunits. Conventionally, the pore size of granular scaffolds is frequently approximated using 2-D z-slice images, where areas of void islands are reported after binarizing and thresholding, or measurements are taken using lines that are manually fit within regions of 2-D void space. Pore size determined conventionally using the diameters of largest enclosed circles may be compared to largest enclosed spheres for void pockets in 2-D slices vs. 3-D subunits, respectively. For rigid, semi-soft, and soft 100 μm diameter particle domains, it was determined that approximating pore diameter using 2-D slice data tends to underestimate pore size and result in wider variation in the data compared to the more accurate 3-D approximations generated by the computing device 102. These trends are more extreme for rigid particle domains, and they lessen as particles become soft and overall void space reduces. This data suggests that largest enclosed sphere diameter is more accurate for representing true pore dimension compared to 2-D analysis. Additionally, a single descriptor may not be enough information to capture the spatial complexity of a pore. Accordingly, as described above, the computing device 102 tackles this problem by describing a pore with 23 measurements. The variation across subunit descriptor data for specific domains speaks to the complexity of pore space.

As mentioned previously, each void subunit may be assigned an isotropy/anisotropy measurement between 0 and 1 that reflects the orientation of its PCA ellipsoid relative to the average orientation. If the collective subunit orientations are random, the resulting distribution will follow a uniform distribution with a lower bound of 0 and an upper bound of 1, which suggests an anisotropic scaffold with respect to the void space. In an example, to validate the isotropy/anisotropy descriptor, a special set of rigid ellipsoid domains with varying levels of particle alignment were generated. It was hypothesized that the inherent directionality of ellipsoids would contribute to directionality of void space subunits and that more aligned (isotropic) ellipsoids would produce isotropic subunits. As a control, the ellipsoid domains were compared against 60 μm diameter rigid spheres in random packing, since a collection of spherical particles inherently does not exhibit alignment due to radial symmetry of the particle shape. As expected, the resulting subunits from spherical particles exhibited anisotropy. Ellipsoids in random packing (anisotropic) produced a distribution that is weakly skewed; a drastic shift was seen for aligned ellipsoids, which generated a heavily skewed distribution. This result is a clear indication that void space pockets are aligned in a similar direction for this domain and can therefore be classified as isotropic. The validity of this metric is confirmed with square packing of ellipsoids in which all subunits are pointing in the same direction, producing a shifted Dirac delta distribution, which is non-uniform between 0 and 1 (FIG. 3l).

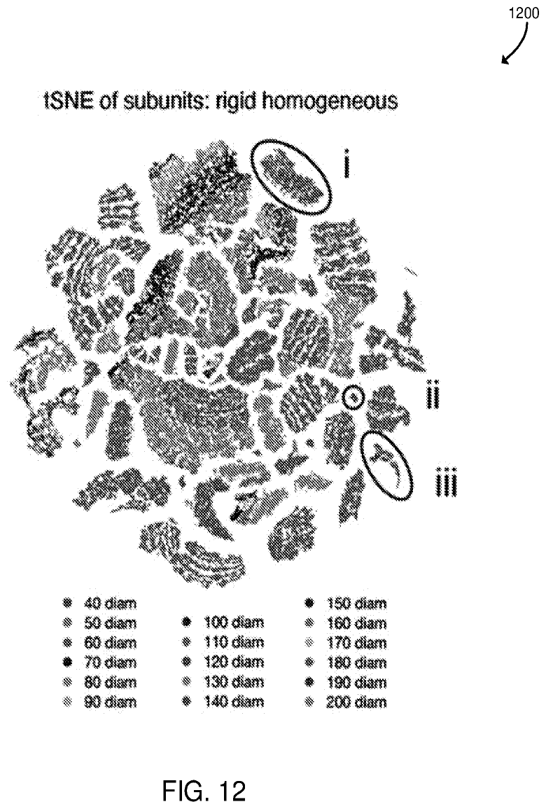

As another example, the subunit data generated by the computing device 102 can be used to identify void space pocket “types” using higher dimensional analysis. Referring now to FIG. 12, diagram 1200 illustrates results of running t-distributed stochastic neighbor embedding (tSNE) on scaffold subunits that are labeled by 17 subunit descriptors. As shown, based on these results, clusters of similar subunits can be identified. In the example, only the interior subunits for each domain were analyzed. Subunits from a given cluster reference a subunit type, and descriptor labels define the type. In the illustrative example shown in FIG. 12, cluster ii and iii were analyzed because of the visual variety in datapoint types within each cluster. Cluster i was also analyzed because it was an example of a visually larger cluster. To extract cluster datapoints from tSNE plots in MATLAB, the brush feature was used. Custom code was developed to relate datapoints to subunits from specific domains, and this information was stored in a cell array, c. The diagram 1200 includes images of subunits from each cluster.

tSNE or any other higher-dimensional method of analysis can also be used to compare the subunits from one scaffold against the subunits found in an array of scaffold standards. For example, it can be verified that packing soft particles creates void space pockets that are not found in rigid particle scaffolds, regardless of the particle size. Interestingly, these subunit types can be seen in scaffolds made from nugget- and rod-shaped particles. Despite the random nature of packed particles, this analysis reveals that there are underlying patterns to the local geometry of void space across scaffold standards generated under similar conditions. Therefore, the computing device 102 may increase confidence for researchers who are designing granular scaffolds with a specific void pocket geometry. Each particle domain may be labeled with its global descriptors, as well as the mean, minimum, lower-, middle-, and upper-quartile, maximum, mode, and peak frequency of all subunit and non-subunit descriptor data (more than 200 measurements in total). Parameters, such as tSNE parameters of perplexity, learning rate, and exaggeration may be optimized for each run.

This analysis can also serve as a numeric “fingerprint” of scaffold types. In this example, information from all descriptors may be used to label each scaffold, and it may be determined which scaffolds cluster with one another. This type may be a tSNE “domain” plot, where objects refer to particle domains. When an experimental “real” MAP scaffold containing ˜100 μm diameter microgels is compared against all of the scaffold standards, it can be determined see that the experimental MAP scaffold clusters with the simulated scaffold containing monodisperse soft 100 μm particles. This result provides evidence that it is possible to characterize MAP scaffolds using a fingerprint defined by descriptors.

As another example, a recent publication investigating the ability of MAP scaffolds to control neuronal progenitor cell (NPC) differentiation found conditions in which neurosphere formation occurred in the void space of MAP scaffolds. Neurospheres have a long history as both in vitro models for studying neurogenesis and neurodegenerative diseases and as organoid precursors. The computing device 102 provides a direct way to study how the underlying microarchitecture of the granular scaffolds impacted NPCs, which was not available previously. As an example, the relationship between NPCs and void space can be explored by analyzing microscope images from this study that display neurospheres in MAP one week after neuronal progenitor cells were seeded in vitro. Note that unlike spread cells, neurospheres do not exert a contractile force that moves the microgels and thus do not lead to changes in the void over time. In an experiment, the computing device 102 was used to process six MAP scaffold samples, which required first converting the microscope images captured with a Nikon C2 confocal microscope and converted to labeled particle domain format using methods previously described. The same code was also used to extract neurosphere data by analyzing the neurosphere confocal channel instead of the particle channel. In the example, combining edge subunits that share scaffold openings was not performed due to the thin nature of the samples, so the segmentation represents 3-D pores from the perspective of the interior only.

To start the analysis, the MAP scaffolds were compared against standards from the library of scaffolds and also subunits that contain neurospheres were highlighted. It was found that MAP subunits appear to be more similar, on average, to simulated domains containing semi-soft particles compared to rigid and soft particles, but with greater variation. Such variability can be attributed to sources such as microscope image quality and image processing steps during segmentation. When descriptor data from subunits containing neurospheres is overlaid, it is seen that neurospheres tend to reside in larger spaces. If 3-D pore connectivity and complexity is related to the number of subunit hallways and peaks, respectively, it is seen that these metrics play little role in dictating where neurospheres form. Two metrics of subunits that contain neurospheres, were examined: total volume (pL) and the volume of the largest enclosed sphere (pL). As expected, subunit volumes are consistently larger than their largest enclosed sphere. The experimental results show remarkable similarity between the distributions of largest enclosed sphere and neurosphere volume. This result indicates that neurosphere size is dictated by the maximum local space available for a sphere to grow.

It was next observed where neurospheres form by studying void space landmarks. A subunit is considered to house a neurosphere if there is greater than 95% overlap between subunit voxels and neurosphere voxels. A neurosphere is determined to lie at a peak if the peak is contained within the neurosphere. A neurosphere is determined to lie at a door if at least 40% of its voxels lie on the other side of a door. On average, the experimental results suggest that neurospheres are more often found at local center points in space (peaks) compared to the narrow regions that separate open spaces (doors) (pvalue 0.0558). This further supports the notion that neuronal progenitor cells in MAP scaffolds form neurospheres in larger, open pockets of void space. Neurospheres at doors likely represent neurosphere movement between subunits, which has been shown to occur, so this data could be used as a metric for this phenomenon.

To capture a deeper complexity about what void space features drive neurosphere formation, tSNE was run on subunits from the MAP scaffolds. The tSNE plot revealed a cluster that contains a predominance of neurospheres. These subunits were extracted to observe the features that distinguish them from other subunits. This cluster, i, represents some of the largest subunits, as indicated by descriptors such as largest enclosed sphere (pL), volume (pL), and mean local thickness (μm). In contrast, when subunits from the cluster containing the fewest neurospheres, cluster ii, were extracted, it was found that these subunits represent some of the smallest spaces in the scaffolds, as indicated by largest enclosed sphere and other descriptors that capture pore size. However, these small subunits in particular have additional distinguishing features-they are like narrow tubes of varying lengths. This is described by the PCA ellipsoid descriptors that show small values for the length of ellipsoid axis 2 and 3, while the principal axis appears randomly distributed. These results indicate that neuronal progenitor cells will avoid forming neurospheres in small, narrow, tubes of space. Lastly, a third distinct cluster, iii, also contains neurospheres. These subunits represent a very specific subunit “type,” with precise values for many descriptors, including those that represent size as well as those that capture information about subunit vertices (tips). These results showcase the ability of the computing device 102 to identify different types of 3-D pores in granular scaffolds, which can be used in conjunction with neurosphere data to examine how void space geometry dictates neurosphere formation in MAP scaffolds.

As another example, the computing device 102 may be used to study the effects of spatial confinement on individual cells. Spatial confinement has been shown to influence cell behaviors, such as polarization of macrophage cells toward pro-healing phenotypes. Untreated bone marrow-derived macrophages (BMDM) are around 17 pL in volume, while BMDMs treated with lipopolysaccharide (LPS) to induce inflammation increase in size to around 51 pL. BMDMs are considered “confined” in spaces less than 4.2 pL in volume. Granular scaffolds are used as a platform for enforcing spatial confinement of BMDMs through embedment of cells within the void space of scaffolds. Since particle size dictates pore size of void space, the computing device 102 as described herein serves as a predictive tool to guide experimental design.

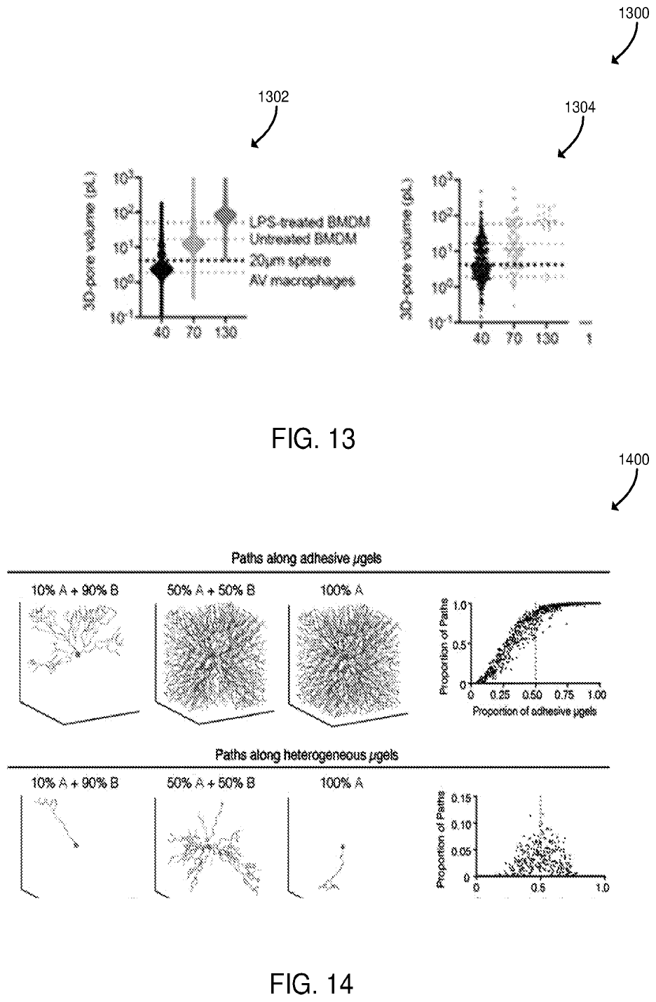

Referring now to FIG. 13, diagram 1300 illustrates experimental results that may be achieved by the computing device 102. In the experiment, the computing device 102 was used to determine the 3D-pore volumes of simulated granular scaffolds comprising different particle sizes. Monodisperse scaffolds comprising 40 μm, 70 μm, and 130 μm diameter particles are identified because they contain median pore volumes that match BMDM confinement, untreated BMDM, and LPS-treated BMDM, respectively. 3D-pore volume for each particle size is determined with the computing device 102, as shown in chart 1302. Monodisperse granular scaffolds are subsequently fabricated in lab with mean particle diameter of 40 μm, 70 μm, and 130 μm. The computing device 102 is then used to confirm 3D-pore volumes of scaffolds fabricated in lab as shown in chart 1304.

Granular scaffolds of different particle sizes are compared for therapeutic effect in murine wound healing models. Since all material properties are held constant among groups, variation in outcomes are attributed to differences in particle size and subsequent void space microarchitecture. The computing device 102 may be used to study void space microarchitecture, which is then correlated with favorable cell behaviors. Continuing the above example, the largest enclosed sphere within 3D-pores was measured for granular scaffolds comprising 40 μm, 70 μm, and 130 μm diameter particles, and it was found that granular scaffolds with pore sizes that can accommodate ˜40 μm diameter spheres induced mature collagen regeneration and reduced levels of inflammation in healing skin wounds. Additional metrics generated by the computing device 102 that may be useful for in vivo studies include the diameter of entrance or exits openings (“doors”) into and out of the scaffold, which is a limiting factor for cell infiltration. In general, the computing device 102 enables researchers to draw conclusions about the role of void space in therapeutic outcomes, which in turn guides biomaterial optimization.

As another example, the computing device 102 used to study collective cell growth in heterogeneous particle populations. Granular scaffolds are used as constructs for guiding cell patterning in 3D, such as de novo assembly of endothelial progenitor-like cells into vessels. Particle surfaces can be modified with cell-adhesion proteins that promote cell migration throughout the scaffold. Strategic placement of such particles within a scaffold can influence growth patterns, which is exhibited in phenomena like vasculogenesis. The computing device 102 was used to study the accessibility of cells to adhesion vs. non-adhesion particles in a heterogeneous mixture. Heterogeneous mixtures of two particle populations (A & B) were simulated at different proportions, and Population B was removed. The computing device 102 identified peaks within the remaining void, and the gap size between particles of Population A was studied. Assuming cells are associating with particles in Population A (e.g., adhesive particles), these gap sizes roughly represent the separation distances between cells that are obstructed from one another by Population B particles (e.g., non-adhesive particles). It was found that at 1:1 mixtures of A and B particles, the average gap size equals the average particle diameter of the removed particles (i.e., Population B). This means the average gap size is a tunable parameter: simply generate Population B particle sizes of your desired gap size, and mix A and B particles at 50% proportion.

Continuing that example, the computing device 102 may be used to study paths within scaffolds comprising heterogeneous mixture of particles. Referring now to FIG. 14, diagram 1400 illustrates experimental results that may be achieved by the computing device 102. A path is the shortest route along 1D-ridges from the center of the scaffold to an exit opening. Paths traverse 3D-pores. In the experiment, it was investigated how different mixtures of Population A (adhesive) and B (non-adhesive) particles influence the availability of certain path types. “Adhesive” paths are those that consistently traverse pores enclosed by at least one adhesive particle. The proportion of “adhesive” paths over all possible paths was reported. At 1:1 particle populations, it was determined that the number of “adhesive” paths nearly equals all possible paths, and the proportion plot plateaus. “Heterogeneous” paths are those that consistently traverse pores enclosed by 40-60% heterogeneous mixtures of particles. The idea is that adhesion “gradients” may be necessary to drive cell migration. The proportion of “heterogeneous” plots are maximized at 1:1 ratios of particle populations. These results may help explain superior vasculogenesis seen in 50% mixtures.

As another example, the computing device 102 may be used to study the size, shape, and likelihood of large pores in different granular scaffolds that lead to scaffold stability. In an experiment, the computing device 102 identified natural open pockets of space (3D-pores) among packed particles, which can be organized by the number of particles that surround each pore. Larger 3D-pores surrounded by more particles is a rare event; however, data generated by the computing device 102 suggests that packed rods (cylinders) and nuggets (flattened egg-like shapes) are more likely to produce these pockets. In addition, the computing device 102 confirmed that mixing large and small particles produces overall smaller pore volumes relative to monodisperse spheres if the smaller particle species can fit within void gaps between larger particles.

As another example, the computing device 102 may be used to segment void space into 3D-pores, enabling the study of flow and mass transport within and between the pores. The computing device 102 may also determine regions data relating to regions of void space available to objects of a specific size. The computing device 102 may also determine ligand data relating to data assigned to particle surfaces, such as ligand concentration.

What is claimed is:

1. A computing device for packed particle analysis, the computing device comprising:
an input manager to obtain labeled input data indicative of a plurality of particles positioned in a scaffold domain;
a particle configuration engine to (i) compute a void space Euclidean distance transform (EDT) for each voxel of void space of the scaffold domain, wherein the void space is defined between the plurality of particles of the labeled input data and (ii) determine a particle configuration based on the labeled input data, wherein the particle configuration is indicative of a neighboring particle graph;
a landmark engine to determine a plurality of medial axis landmarks based on the EDT and the particle configuration, wherein each medial axis landmark comprises a voxel of void space that is a 2D-ridge, a 1D-ridge, or a peak; and
a segmentation engine to segment the void space into a plurality of subunits based on the plurality of medial axis landmarks.

2. The computing device of claim 1, wherein to obtain the labeled input data comprises to generate the labeled input data based on image data from an imaging system.

3. The computing device of claim 1, wherein to obtain the labeled input data comprises to simulate particle packing of the plurality of particles.

4. The computing device of claim 1, wherein to compute the void space EDT comprises to compute an EDT for each particle of the plurality of particles.

5. The computing device of claim 4, wherein to compute the void space EDT for each particle comprises to compute an EDT within a bounding box centered at each particle whose size is determined by a maximum EDT value of the scaffold domain.

6. The computing device of claim 1, wherein to determine the plurality of medial axis landmarks comprises to generate tag data for each voxel, wherein the tag data for each voxel is indicative of any particles to the voxel is equidistant.

7. The computing device of claim 6, wherein to determine the plurality of medial axis landmarks comprises to identify voxels as 2D-ridge voxels based on the tag data, wherein each voxel that is associated with a 2D-ridge is equidistant from exactly two particles.

8. The computing device of claim 6, wherein to determine the plurality of medial axis landmarks comprises to identify one or more voxels as 1D-ridge voxels, wherein each 1D-ridge voxel is at an intersection of a plurality of 2D-ridges, wherein to identify the 1D-ridge voxels further comprises to:
determine a set of smallest loops in the neighboring particle graph, which corresponds to the 1D-ridge voxels; and
associate voxels to each smallest loop in the neighboring particle graph using the tag data.

9. The computing device of claim 6, wherein to determine the plurality of medial axis landmarks comprises to identify voxels as peak voxels, wherein each peak voxel is at an intersection of a plurality of 1D-ridges, wherein to identify the peak voxels further comprises to:
cluster medial axis voxels that share particle neighbors;
for each cluster, identify voxels equidistant to the largest number of particles; and
of the voxels equidistant to the largest number of particles, identify a voxel with the maximum EDT value as a peak.

10. The computing device of claim 1, wherein to segment the void space further comprises to associate peaks of the medial axis to define a subunit of the plurality of subunits, wherein to associate the peaks comprises to:
determine a Euclidean distance between pairs of peaks;
determine whether the Euclidean distance is less than a sum of EDT values associated with each peak of the pair of peaks;
associate the pair of peaks in response to a determination that the Euclidean distance is less than the sum of EDT values; and
partition the set of all peaks into subunits, wherein peaks within each subunit are associated with at least one other peak in the subunit.

11. The computing device of claim 10, wherein to segment the void space further comprises to use a graph of peaks and 1D-ridges to associate 1D-ridges with peaks of a subunit to define the backbone of the subunit, wherein to associate 1D-ridges comprises to:
identify the minimum EDT value along each 1D-ridge;
associate a portion of the 1D-ridge that is closest to the peak of a subunit; and
assign remaining void space voxels to the subunit associated with a nearest backbone voxel.

12. The computing device of claim 1, the segmentation engine is further to segment openings of the plurality of particles along a boundary surface of void space into surface subunits.

13. The computing device of claim 12, wherein to segment the openings comprises to:
compute an EDT of the void space surface;
identify ridge and peak voxels along the void space surface with the EDT;
threshold EDT values along the medial axis to form backbone islands that define the surface subunits; and
assign remaining void space surface voxels to the surface subunit with a nearest backbone voxel.

14. The computing device of claim 12, wherein the segmentation engine is further to merge the plurality of subunits with a the plurality of surface subunits of the plurality of particles, wherein to merge the plurality of subunits with the plurality of surface subunits comprises to combine subunits that contain voxels associated with the same surface subunit.

15. The computing device of claim 1, further comprising an analysis engine to generate a plurality of scaffold descriptors in response to determination of the medial axis landmarks and segmentation of the void space, wherein the plurality of scaffold descriptors comprises global descriptors, subunit descriptors, and non-subunit descriptors.

16. The computing device of claim 15, wherein the analysis engine is further to analyze the plurality of scaffold descriptors, wherein to analyze the plurality of scaffold descriptors comprises to:
compute size metrics across the plurality of subunits in the scaffold domain;
compute connectivity metrics across the scaffold domain;
compute path and available regions metrics for an object traversing the void space in the scaffold domain;
compute ligand availability metrics for the scaffold domain; or
compute isotropy metrics across the plurality of subunits.

17. The computing device of claim 15, wherein the analysis engine is further to apply higher dimensional analysis techniques to the plurality of scaffold descriptors, wherein to apply the higher dimensional analysis techniques comprises to:
identify subunit types as defined by descriptor values; or
identify scaffold domain fingerprints as defined by descriptor values.

18. A method for packed particle analysis, the method comprising:
obtaining, by a computing device, labeled input data indicative of a plurality of particles positioned in a scaffold domain;
computing, by the computing device, a void space Euclidean distance transform (EDT) for each voxel of void space of the scaffold domain, wherein the void space is defined between the plurality of particles of the labeled input data;
determining, by the computing device, a particle configuration based on the labeled input data, wherein the particle configuration is indicative of a neighboring particle graph;
determining, by the computing device, a plurality of medial axis landmarks based on the EDT and the particle configuration, wherein each medial axis landmark comprises a voxel of void space that is a 2D-ridge, a 1D-ridge, or a peak; and
segmenting, by the computing device, the void space into a plurality of subunits based on the plurality of medial axis landmarks.

19. The method of claim 18, wherein computing the void space EDT comprises computing an EDT for each particle of the plurality of particles.

20. The method of claim 18, wherein determining the plurality of medial axis landmarks comprises generating tag data for each voxel, wherein the tag data for each voxel is indicative of any particles to the voxel is equidistant.

21. The method of claim 20, wherein determining the plurality of medial axis landmarks comprises identifying one or more voxels as 1D-ridge voxels, wherein each 1D-ridge voxel is at an intersection of a plurality of 2D-ridges, wherein identifying the 1D-ridge voxels further comprises:
determining a set of smallest loops in the neighboring particle graph, which corresponds to the 1D-ridge voxels; and
associating voxels to each smallest loop in the neighboring particle graph using the tag data.

22. The method of claim 20, wherein determining the plurality of medial axis landmarks comprises identifying voxels as peak voxels, wherein each peak voxel is at an intersection of a plurality of 1D-ridges, wherein identifying the peak voxels further comprises:
clustering medial axis voxels that share particle neighbors;
for each cluster, identifying voxels equidistant to the largest number of particles; and
of the voxels equidistant to the largest number of particles, identifying a voxel with the maximum EDT value as a peak.

23. The method of claim 18, wherein segmenting the void space further comprises associating peaks of the medial axis to define a subunit of the plurality of subunits, wherein associating the peaks comprises:
determining a Euclidean distance between pairs of peaks;
determining whether the Euclidean distance is less than a sum of EDT values associated with each peak of the pair of peaks;
associating the pair of peaks in response to determining that the Euclidean distance is less than the sum of EDT values; and
partitioning the set of all peaks into subunits, wherein peaks within each subunit are associated with at least one other peak in the subunit.

24. The method of claim 18, further comprising segmenting, by the computing device, openings of the plurality of particles along a boundary surface of void space into surface subunits.

25. The method of claim 18, further comprising generating, by the computing device, a plurality of scaffold descriptors in response determining of the medial axis landmarks and segmenting the void space, wherein the plurality of scaffold descriptors comprises global descriptors, subunit descriptors, and non-subunit descriptors.
